(19) United States
(12) Patent Application Publication
(10) Pub. No.: US 2020/0403490 A1
(43) Pub. Date: Dec. 24, 2020

(54) APPARATUS AND METHODS FOR GENERATING CLEAN ENERGY USING MAGNETIC FORCE AND TANGENTIAL MAGNETIC ACCELERATION FORCE

(71) Applicant: Paola COLE, Redlands, CA (US)

(72) Inventor: Charles D. COLE, III, Redlands, CA (US)

(21) Appl. No.: 16/484,262

(22) PCT Filed: Feb. 7, 2018
(86) PCT No.: PCT/US2018/017248

§ 371 Date: Aug. 7, 2019

Related U.S. Application Data
(60) Provisional application No. 62/474,964, filed on Mar. 22, 2017.
(60) Provisional application No. 62/455,976, filed on Feb. 7, 2017.

(51) Int. Cl. H02K 53/00; H02K 35/02

(52) U.S. Cl. CPC H02K 53/00; H02K 35/02

(57) ABSTRACT

Exemplary embodiments of the present invention would provide ultra high-speed spinning magnet(s) in an ultra low friction environment that generate clean power when spinning above a certain RPM. Exemplary embodiments of the present invention would provide an apparatus that produces a magnetic acceleration force and that generates electrical energy using that force. One exemplary embodiment apparatus would comprise: a rotor that orbits opposing-magnetic poles of one or more magnets, generating a magnetic acceleration force; and a wire coil that receives as electrical energy the magnetic acceleration force created by the rotor orbiting two opposing-poles of one or more magnets at very high speeds and that transfers said electrical energy for power generation.

### CROSS-REFERENCE TO RELATED APPLICATIONS

This application is related to, and claims priority to, U.S. Provisional Application Ser. No. 62/474,964, filed Mar. 22, 2017, entitled “APPARATUS AND METHODS FOR GENERATING CLEAN ENERGY RESULTING FROM GRAVITATIONAL AND MAGNETIC DARK ENERGY VECTORS,” and to U.S. Provisional Application Ser. No. 62/455,976, filed Feb. 7, 2017, entitled “APPARATUS AND METHODS FOR GENERATING CLEAN ENERGY RESULTING FROM GRAVITATIONAL AND MAGNETIC DARK ENERGY VECTORS,” the entire contents and disclosures of which are incorporated for all purposes by reference herein as if fully stated herein.

This application is related to U.S. Provisional Application Ser. No. 62/141,006, filed Mar. 31, 2015, entitled “APPARATUS AND METHODS FOR GENERATING CLEAN ENERGY RESULTING FROM GRAVITATIONAL AND MAGNETIC DARK ENERGY VECTORS,” and to U.S. Provisional Application Ser. No. 62/159,596, filed May 11, 2015, entitled “APPARATUS AND METHODS FOR GENERATING CLEAN ENERGY RESULTING FROM GRAVITATIONAL AND MAGNETIC DARK ENERGY VECTORS,” the entire contents and disclosures of which are incorporated for all purposes by reference herein as if fully stated herein.

### FIELD OF THE INVENTION

The field of the present invention is generating clean energy, and in particular, generating clean energy using energy that is created by orbiting, or otherwise counter posing moving, opposing magnetic poles.

### BACKGROUND OF THE INVENTION

As explained further below, rotating-magnet magnetic and tangential magnetic (magnetic Dark Energy) forces can be generated and harnessed to produce clean energy.

That is because, as explained further below, magnets rotated around a central point, such as a massless central point, generate magnetic forces, and tangential magnetic forces, that analogous to the gravitational forces, and tangential gravitational forces, that are generated when masses of ordinary matter rotate around a central point, such as a massless central point.

As still further explained below, in view of the analogous nature of the magnetic and tangential magnetic forces generated by rotating magnets as compared to gravitational and tangential gravitational forces, such rotating-magnet magnetic and tangential magnetic forces can be generated and harnessed to produce clean energy.

As yet further explained below, the heretofore-considered “phenomenon” of “Dark Matter” and “Dark Energy” are merely effects of gravitational forces of ordinary masses that rotate, such as around a central [massless] point. Rotation around a massless central point gives the greatest percentage of dark energy.

According to prevalent scientific theories explained in WikipediA™, “[d]ark matter is a hypothetical type of matter distinct from ordinary matter such as protons, neutrons, electrons and neutrinos.” (Emphasis added). According to prevalent scientific theories explained in WikipediA™, “[t]he name [Dark Matter] refers to the fact that it does not emit or interact with observable electromagnetic radiation, such as light, and is thus invisible to the entire electromagnetic spectrum.” Further, according to prevalent scientific theories explained in WikipediA™, “[a]lthough dark matter has not been directly observed, its existence and properties are inferred from unexplained mass in gravitational lensing calculations, which affects the motions of baryonic matter and light. (citations omitted). It influences the universe's large-scale structure, the formation of galaxies, and affects the cosmic microwave background.” (Emphasis added).

Although dark matter may not have been directly observed, the prevalent scientific theories explained in WikipediA™ go onto explain that “[t]he standard model of cosmology indicates that the total mass-energy of the universe contains 4.9% ordinary matter, 26.8% dark matter and 68.3% dark energy.” (Citations omitted; emphasis added).

According to Merriam-Webster™ (online), “dark energy” is “a hypothetical form of energy that produces a force that opposes gravity and is thought to be the cause of the accelerating expansion of the universe.”

That is, according to prevailing scientific theories, approximately 95% of our universe is made up of “hypothetical” dark matter (26.8%) and “hypothetical” dark energy (68.3%).

However, as explained by papers authored by the inventor of the present invention (which are incorporated by reference herein for all purposes as if fully stated here), previously-ignored gravitational forces explain that both Dark Energy and Dark Matter are actually effects of gravity of existing “ordinary” matter, and more specifically, are effects of gravity of bodies of ordinary matter that are rotating around a central point.

In particular, one paper by the present inventor, entitled “Breaking Kepler's Law¹,” corrects a 400-year-old math error in Kepler's Third Law. That is, Kepler's “Third Law”, from which Newton's Law of Gravity was derived, makes an assumption that limits the usefulness of that law. Namely, the Kepler curve as known, only serves as the limit at one end of a field of curves based on the equation: ¹ Breaking Kepler's Law; The Kepler Curve Modified For a Finite Speed of Gravity, Charles D. Cole, III, www.skysthelimit.com.

$$\frac{\begin{matrix}Central Mass of Orbiting System \\ ( e . g . , a supermassive black hole )\end{matrix}}{\begin{matrix}Total Mass of Orbiting System \\ ( e . g . , an entire galaxy )\end{matrix}}$$

As explained in more detail in the “Breaking Kepler's Law” paper mentioned above, Kepler's Third Law, V=1/√r, assumes that the central mass of the orbiting system is 100%. The characteristic rotation curve that follows, reduces to V=1/√r. However, at the extreme, such as where equal masses orbit each other (with a massless central point), very different curves, known as “Galactic Rotation Curves,” are produced.

The above-mentioned Kepler-“type” “Galactic Rotation Curves” explain that what has heretofore been hypothesized to be “Dark Matter” is merely an effect of gravity, not a particle as previously thought. But the “Dark Energy” component depicted in those curves is a far more important piece of information. In particular, the “Dark Energy” component is depicted at the end of the Kepler-“type” “Galactic Rotation Curves”—the ends of those curves match and predict the “Dark Energy” that was first “discovered” in 1998.

Further, the “Galactic Rotation Curves” serve as empirical evidence that the speed of gravity travels at almost 1,000 times slower than the speed of light.

Newton's Equation for the Force of Gravity, which was derived from Kepler's Third Law, is:

Fg=G(m₁m₂)÷r²

In Newton's Force of Gravity Equation shown above, “r” represents the distance between the center of mass of two masses that is traveled by gravity. Newton assumed that gravitational forces traveled infinitely fast—that is, Newton's Equation for the Force of Gravity otherwise ignored the speed at which gravity travels. But, as mentioned above, and as explained in more detail below and in the papers authored by the inventor of the present invention (which are incorporated by reference herein for all purposes as if fully stated here), the speed at which gravity travels in not infinitely fast, nor does it travel at the speed of light, as other scientists had assumed, but rather, travels at almost 1,000 times slower than the speed of light.

As explained in more detail below and in the papers authored by the inventor of the present invention (which are incorporated by reference herein for all purposes as if fully stated here), the above-mentioned lag time in the speed at which gravity travels results in force vectors that were ignored by Newton's and Kepler's laws, and which explain the effects that have heretofore been hypothesized as being due to “Dark Matter” and “Dark Energy;” these gravitational force vectors not only explain the “Dark Matter” and “Dark Energy” effects, but further explain them in terms of both magnitude and direction.

Switching from gravity to magnetism, the precise speed at which the force of magnetism travels is not currently known. However, as explained in more detail below and in the papers authored by the inventor of the present invention (which are incorporated by reference herein for all purposes as if fully stated here), the equations for magnetism are analogous to the equations for gravity. Therefore, using similar Newtonian math as explained above corrected for the speed at which gravity and magnetism travel, implies that magnetic Dark Energy would be a result of the retarded potential of magnets in orbit. That is, magnetic forces and tangential magnetic forces would be generated by rotating magnets around a central massless orbit, that would be analogous to the gravitational forces generated by mutually orbiting masses around a central massless point as a result of the lag time at which gravity travels. Therefore, the corrected Newtonian math implies that magnetic Dark Energy could be generated as a result of the retarded potential of mutually orbiting magnets that could be used to power a generator.

Such a magnetic Dark Energy generator would have zero emissions, would work better in space, would not need very much additional fuel, once initiated, and would be ideal for generating unlimited amounts of low energy power such as replacements for all power plants (coal, atomic power, etc.).

Because magnetic Dark Energy can be generated anywhere, such a power source would be ideal for space travel and would be far easier to construct in an environment absent earth's gravity.

Motors and generators that use magnets and electromagnetism have been around for decades. In very simple terms, in the past, magnets would be rotated within an electric coil to generate electricity. The magnets would be set on some configuration on a rotor. A wire coil would be presented on a stator. The rotor would be connected to a drive engine to cause rotation of the rotor inside the coil of wire mounted inside the stator.

In some exemplary embodiments of the present invention, an initial drive motor would be used to start rotation of a rotor to which alternating opposing magnetic pole magnets would be mounted. The job of the initial drive motor would be to drive the revolution of the rotor up to a high speed (a certain number of revolutions per minute (“RPMs”), as discussed further below, preferably, in an ultra-low-friction environment, so that the magnets would be rotating so fast around a mutual orbit, that, as between two adjacent, alternating opposing pole magnets, the lead magnet would emit a magnetic force that would attract the adjacent following magnet to a location that had been occupied by the lead magnet prior to the lead magnet having been rotated away from that location.

In order to explain the magnetic force and tangential magnetic acceleration force effects that would be harnessed by exemplary embodiments disclosed hereinbelow, it will be helpful to first consider the underpinnings regarding gravitational forces.

In particular, there has been a discrepancy between certain star velocities that may be calculated according to currently accepted physics theories using Kepler's equations for orbital velocity as compared to actual observed star velocities.

Notably, this and other aspects of the gravitational force, and tangential gravitational acceleration force effect, disclosed hereinbelow, are described in more detail in certain papers that have been published on the Internet at www.skysthelimit.com, including but not limited to: the paper entitled “Breaking Newton's Law,” Charles D. Cole, copyright 2016, as published at www.skysthelimit.com, the contents and disclosure of which are incorporated herein for all purposes by reference as if stated in full herein; the paper entitled “Breaking Kepler's Law: The Kepler Curve Modified for a Finite Speed of Gravity,” Charles D. Cole, copyright 2016, as published at www.skysthelimit.com, the contents and disclosure of which are incorporated herein for all purposes by reference as if stated in full herein; the paper entitled “A Tale of Two Physics,” Charles D. Cole, copyright 2016, as published at www.skysthelimit.com, the contents and disclosure of which are incorporated herein for all purposes by reference as if stated in full herein; and the paper entitled “Geometric Consequences of a Finite Gravitational Speed,” Charles D. Cole, copyright 2016, as published at www.skysthelimit.com, the contents and disclosure of which are incorporated herein for all purposes by reference as if stated in full herein.

The above-referenced paper entitled “Breaking Kepler's Law: The Kepler Curve Modified for a Finite Speed of Gravity,” provides a derivation of a “Galactic Rotation Curve” using Kepler's Law and r′.

The above-referenced paper entitled “Geometric Consequences of a Finite Gravitational Speed” provides a geometric view of the reason that galaxies exhibit approximately 5.6 times the gravitational force that would be predicted by Newton's Law and provides a geometric proof of a possible “speed” at which gravity travels.

The above-referenced paper entitled “A Tale of Two Physics” explains why the theory of relativity does not accurately predict mass in certain situations, which has resulted in a theory of “dark matter.”

The explanations provided by the various above-referenced papers, and summarized briefly below, explain the gravitational force effect that has a close parallel with respect to magnetic forces; it is the magnetic force effects (that parallel the gravitational force effects by the various above-referenced papers, and hereinbelow), that would be harnessed by exemplary embodiments disclosed hereinbelow.

Historical Newtonian Physics

In the 1920s, Astronomer Jan Oort discovered that, at great distances, stars in the outermost orbits of galaxies are orbiting faster than can be explained by normal Newtonian physics and the resulting Keplerian orbit calculations. Because these stars stay in an orbit at a far faster rate than predicted by Kepler, astronomer Fritz Zwicky theorized that “Dark Matter” was the extra source of gravity that is pulling them in and keeping them from flying out of orbit.

In 1998, scientists discovered that the outermost of the outermost stars are actually accelerating away from the galactic center, as if there is some force propelling the outermost stars outwards. This outward-accelerating force is in stark defiance of gravity, of “Dark Matter,” and of the laws of thermodynamics. Of the two dark force vectors, the “Dark Energy” vector is the one that supposedly can create power (and take it away) although as explained further below, they are both intimately connected.

The chart depicted in FIG. 1 depicts star velocity along the Y-axis and distance (from the center of the galaxy) along an X-axis. In the chart depicted in FIG. 1, a line labelled “A” plots the expected velocity of stars at specific distances from the galactic center according to Kepler's equation for orbital velocities. The chart depicted in FIG. 1 also shows along a line labelled “B,” the actual observed speed of stars as plotted against their distance from the galactic center. The difference between lines “A” and “B” depicted in the chart shown in FIG. 1 represents the difference between predicted velocities calculated according to the currently (historically) accepted Kepler's orbital equation for orbital velocities as compared to actual observed velocities.

As will be understood by someone with ordinary skill in the art, there is an accepted scientific theory regarding “Dark Matter” that attempts to explain why the outermost stars can orbit their galaxy at such high speeds that, without some further explanation, such as the scientist-proffered existence of “Dark Matter,” would cause those stars to fly out of orbit. According to the theory, “Dark Matter” is scattered about the galaxies; Dark Matter is invisible, and cannot be smelled or touched. According to the theory, this invisible “Dark Matter” supposedly emits enough gravity to keep those fast-orbiting stars from escaping their respective orbits.

As will be understood by someone with ordinary skill in the art, there is also an accepted scientific theory regarding “Dark Energy.” According to the theory, “Dark Energy” is a kind of force that does the opposite of “Dark Matter” in that Dark Energy supposedly comprises a mysterious force that pushes the outer stars away from the galactic center; the theory does not offer any cause of “Dark Energy.”

The above-mentioned theories regarding “Dark Matter” and/or “Dark Energy” have emerged to try to explain, at least in part, the above-mentioned discrepancies (between the discoveries of Oort, as compared to the theories of Newton and Kepler). However, the “Dark Matter” theories (that theorize invisible matter that emits enough gravity to keep fast-moving stars from escaping their respective orbits) do not explain, but rather work against, the above-mentioned theories regarding “Dark Energy” (that supposedly cause outward star acceleration).

Rather than some as-yet-unproven existence of “Dark Matter” or “Dark Energy,” a better understanding of various aspects of gravity explains the above-mentioned discrepancies.

But before examining the various aspects of gravity, first revisiting various properties of light may be helpful.

The speed of light is known. In particular, the speed of light in a vacuum, commonly denoted in physics equations as “c”, is a physical constant of 299,792,458 meters per second; 186,000 miles per second; 671 million miles per hour.

Once light is emitted, the existence of that light is independent of any new location of the body that emitted that light. Because of the distance between the Sun and the Earth, light emitted from the Sun takes a little over eight minutes to reach the Earth. Therefore, even though the speed of light is extremely fast, if a person were to focus a telescope directly at the Sun, because the Earth is orbiting the Sun, and because it takes eight minutes for the light of the Sun to reach the earth, the telescope would be focused on the spot where the sun used to be eight minutes earlier, as compared to the actual position of the sun.

FIG. 2A depicts an exemplary general case showing the changing location of the earth during an exemplary eight minutes time of travel. In particular, FIG. 2A depicts the Earth's orbit 401 around the Sun 400. FIG. 2A further depicts light 420 emitted by the Sun at time t₁. As will be understood by someone with ordinary skill in the art, the Sun emits light in a sphere. However, in order to depict the time-delay in the Earth (410 at time t₁; 410′ at time t₂) receiving the Sun's light, only a portion of the sphere of light emitted by the Sun is depicted in FIG. 2A as element 420.

FIG. 2A yet further depicts the same stationary location of the Sun as at time t₁ at time t₂. FIG. 2A also depicts Earth (410 and 410′) in its orbit 401 around the Sun at times t₁ and t₂ respectively.

As depicted in FIG. 2A, the Sun's light that is “seen” by Earth at time t₂ 410′ is the light 420 that was emitted by the Sun 400 at time t₁.

FIG. 2B provides an alternative depiction of a person 11 on Earth viewing the Sun 13. As illustratively depicted in FIG. 2B, when (at time t₂) a person 11 on Earth that points a telescope 12 at the apparent position of the Sun 13 at time t₂, the Sun's Actual Position 14 at time t₂ is different than the apparent position of the Sun 13 when the Sun emitted the light at which the telescope 12 is pointed.

Gravitational force shares some similarity with the aforementioned properties of light. Similar to light, once a mass originates a gravitational force, the existence of that gravitational force is independent of any new location of the mass from which the gravitational force originated. Also, as will be understood by someone with ordinary skill in the art, similar to light, gravitational force is emitted in a sphere by the emitting mass. However, for purposes of illustration, an illustrative straight-line view of gravity is depicted in the figures of this application.

But, as will be understood by someone with ordinary skill in the art, as distinguished from light, once a gravitational force reaches a receiving mass at time t₂, the gravitational force “pulls” the receiving mass in the direction from which the gravitational-emitting mass was at time t₁, whereas the light emitted at t₁ travels along the same axis as, and, to a small extent, “pushes” the receiving mass.

Notably, the speed of light is also considered by some scientific theories to be the speed at which massless particles and changes of associated fields, including gravitational waves, travel in a vacuum. However, there are also long-standing scientific theories that assume that gravity travels infinitely fast, as further discussed below.

There is a phenomenon that was first pointed out by Fatio de Duillier (1664-1753) in 1690. Either he or Le Sage named it the “Shadow” theory. In the late 1700s, French mathematician George-Louise Le Sage (1724-1803), and French mathematician and astrophysicist Pierre-Simon Laplace, may have foreshadowed the existence of “Dark Energy.” However, it may be that they did not necessarily believe what they had found. That is because the consequences of what they uncovered were too far from what was “known” to be true at that time.

In particular, it appears that Laplace may have identified the “Dark Energy” component (but not the “Dark Matter” component) in 1804 as causing orbits to be unstable. He termed this dark energy effect, the “shadow” effect. However, the astronomical view at the time was that orbits were stable, so Laplace calculated that gravity traveled either instantaneously (infinitely fast), or at something like seven million times the speed of light (a number that was sometimes used during the first part of the 19th century). He did this calculation by using the (then-rumored) 1 arc second per century slowing of the moon as his only empirical result to base his theory on despite the very shaky astronomy of the time. In making his calculations, he relied on many-centuries-old records of eclipses. He might not have taken into account the change in the velocity of the Earth's rotation which among other reasons, threw off his calculations.

In more recent times, it has been discovered that galactic orbits are not stable.

Despite the relatively recent realization that orbits are not stable, it has been believed for over a hundred years, and it is still believed, that that when looked at mechanistically, the force of gravity is considered to travel infinitely fast. However, on the other hand, when viewed relativistically, gravity has been viewed as traveling at the speed of light. It cannot be both ways—it is one or the other—either instantaneous, or some speed less than instantaneous.

The effect of the force of gravity is sometimes referred to herein as the “reach” of gravity. The speed at which the force of gravity travels is sometimes referred to herein as the “speed of the reach of gravity,” or as the “speed of gravity.”

If the speed of the reach of gravity is something less than infinitely fast/instantaneous, what is the speed of the reach of gravity?

Since there was no empirical evidence to suggest otherwise, the physicists' conclusion that Le Sage's and/or Laplace's shadow effect must be impossible, may have been logical at the time. However, as mentioned above, it appears that Laplace saw only the “Dark Energy” component (which he called the shadow effect) and missed what has more recently been described as the “Dark Matter” component (which together with stellar wind, largely balances the Dark Energy force at close distances, such as seen in solar systems).

Empirical evidence of the “shadow” effect that Laplace had apparently suspected would not exist for another 200 years after Laplace's work. As explained in more detail hereinbelow and in the above-referenced papers incorporated by reference herein, geometry shows that all gravitational orbits would be unstable if gravity travels at anything less than instantaneous/infinitely fast. And if gravity travels at anything less than instantaneous/infinitely fast, two separate force vectors appear with two separate results—One force vector, sometimes referred to herein as a tangential gravitational acceleration force (sometimes referred to herein as a force “vector”), (also sometimes referred to herein as a “Dark Energy” force vector), explains the effect postulated by many scientists regarding Dark Energy; a second force (also sometimes referred to herein as a force “vector”), sometimes referred to as a gravitational force vector, explains the effect that many have theorized to be created by “Dark Matter.” For the reasons explained further below, the existence of “Dark Matter” is disputed. Rather, for the reasons explained further below, what has been postulated by others to be “Dark Matter,” is instead a force (shown in the figures to this application as a force vector) that is created by the lag of the reach of gravity between two mutually orbiting bodies.

Laplace's calculation for the speed of the force of gravity appears to have been used for a while in the early 1800s as the speed of the reach of gravity. However, that speed calculation eventually fell into disuse. Eventually, and even today, the speed of gravity is, on the one hand, considered by most to be the same as the speed of light. On the other hand, when expedient, as in this case, gravity has been considered by some to travel infinitely fast, or in a literal sense, be instantaneous in all directions, at all distances.

For much of the discussion in this patent application, the speed of the reach of the force of gravity has been assumed, for the sake of illustration and the sake of argument only, to be the long-accepted speed equivalent to the speed of light. However, as further explained below, and as explained in more detail herein and in the above-referenced papers incorporated by reference herein, the speed of the reach of the force of gravity is actually much slower (approximately 857 times slower) than the speed of light (approximately 0.125% of the speed of light). In particular, the above-referenced papers incorporated by reference herein, set forth mathematical proofs and calculations of the speed of the reach of the force of gravity.

Returning with reference to the calculations of Laplace, Laplace had to do all his work within the framework of a single galaxy universe. Important effects like the solar wind were unheard of (the solar wind, because it travels even slower than gravity, actually vigorously works against the ‘dark’ effects). Telescopes were primitive. Orbits were considered to be stable. Dark energy effects in a single galaxy universe are very, very small.

Laplace was “proven” wrong using the astronomy and physics of the time—that “proof” led to the denial of Laplace's prediction of the “Dark Energy” force. However, the force vectors explained further below seem to explain not only the “Dark Energy” force, but also the gravitational-like force that others have theorized to be the result of what they have termed “Dark Matter.”

Since Laplace's time, it has been discovered that orbits, both large and small, are unstable. As discussed further below in this patent application, although Laplace's calculations were off-track, Laplace's initial belief in the “shadow” effect due to the speed at which the force of gravity travels was fundamentally right.

As mentioned above, and as explained in more detail below, the shadow effect due to the speed at which the force of gravity travels creates forces (shown as force “vectors”). However, because of the sheer magnitude of the distances, speeds and forces, it would be extremely difficult with today's technology, to harness those forces and use them to generate energy. However, the shadow effect due to the speed at which the force of gravity travels should translate to electromagnetism in particular and likely, to all orbits governed by the four forces (electromagnetism, gravity, small force and weak force). Therefore, as further described below, we can actually harness the magnetic force parallel of the “Dark Energy” force [vector] as that magnetic force [vector] manifests from the mutual orbit of magnetized bodies.

The speed at which the Sun's gravitational force travels from the Sun to the Earth has not previously been completely clear. For purposes of the initial discussion below, the speed at which a gravitational force travels is assumed to equate with the speed of light. However, in addition, a calculation and mathematical proof of an approximate speed of the reach of gravity is provided further below (and as explained in the above-referenced papers incorporated by reference herein), and shows that the approximate speed is 0.25% of the speed of light (or roughly, 400 times slower than the speed of light).

Even though the speed at which a gravitational force travels may be in question, with respect to FIG. 2A, the gravitational force emitted by the Sun could be viewed to be very similar to the light emitted by the Sun; the gravitational force emitted by the Sun at time t₁ would reach the planet Earth by the time the Earth had changed its location at time t₁ to its location at time t₂, where times t₁ and t₂ are a function of the time it takes the Sun's gravitational force to travel to the Earth.

In a sense, the speed of gravity's reach is unimportant as to if the (Dark Energy) effect will be seen, but is important as to how much it will show itself. The geometry supports that all orbits are unstable (in the long term) at any gravitational force speed that is less than instantaneous.

The speed at which a gravitational force travels may not seem to create any difference with respect to a body that orbits a close and substantially larger body, such as the Earth orbiting the. Sun. As discussed in the above-referenced papers incorporated by reference herein, dark effects are too small to be measured well in a multi-planet solar system, and are easily hidden in the noise, and are more or less balanced out by the effects of the solar wind. However, the effect of the speed at which the gravitational force(s) travel between two stars in mutual orbit greatly influences the “Dark Energy” and “Dark Matter” force effects between them.

As explained further below, Dark Energy and the Dark Matter effect arise from the effects of gravity between two mutually orbiting bodies, such as, for example, two mutually orbiting stars.

Before explaining more detail about mutually orbiting masses, it may be helpful to first consider that in solar systems, such as ours, and as partially depicted in FIG. 2A, a large central mass (e.g., our Sun, depicted in FIG. 2A as element 400) is orbited by much smaller orbiting masses (e.g., Earth (depicted in FIG. 2A as element 410 at time t₁ and as element 410′ at time t₂) and the other planets of our solar system. In our particular solar system, each planet orbits the Sun on its own orbit. Kepler's equation assumes a large central mass orbited by a small, or even negligible, mass, such as Earth's orbit around the Sun.

As compared to a solar system such as ours, galaxies have an orbit with little central mass. Rather, in galaxies, stars of similar masses mutually “orbit” around a substantially-massless orbit center. A substantially-massless center, in the case of the Milly Way, could mean about a 15% central mass.

As explained in more detail below, the above-mentioned mutual orbiting of stars in galaxies produces gravitational energy effects that have heretofore been attributed to unproven theories of “Dark Matter.”

With the above-described substantially-massless-center orbit of stars in galaxies in mind, consider a “gravitational telescope,” i.e., a “telescope” that focuses on gravity force rather than light. Consider an exemplary “gravitational telescope” and two mutually orbiting bodies (e.g., stars) A and B as depicted in FIG. 3. As depicted in FIG. 3, star-body A, orbiting around mutual orbit 20, at time t₁ 1 emits a gravitational force 40 that travels to reach star-body B, also orbiting around mutual orbit 20, in orbit direction 25, at time t₂ 4. The exemplary mutual orbit 20 depicted in FIG. 3 depicts a direct “starting” counter-position of exemplary star-bodies A and B.

So, it could be said that pointing a “gravitational telescope” located on star-body B toward the gravitational force being emitted by star-body A would result in the gravitational telescope located on star-body B at time t₂ 4 being pointed at the location of star-body A at time t₁ 1 along gravitational force line 40. Further, it could be said that star-body B at time t₂ 4 is pulled in the direction of the location of star-body A at time t₁ 1 along gravitational force line 40.

Similarly, it could be said that star-body A at time t₂ 2 is pulled in the direction of the location of star-body B at time t₁ 3 along gravitational force line 70.

A dotted line 10 is depicted between a location of star-body A at time t₁ 1 and a location of star-body B at time t₁ 3. Dotted line 10 depicts a hypothetical case where the gravitational forces emitted by star-bodies A and B respectively were instantaneously experienced at time t₁ by the respective star-bodies B and A, without regard to any distance between the two star-bodies.

However, in view of the theory that gravitational forces travel at some speed that is less than instantaneous, such as, for example, at the long-held theory that it travels at the speed of light in a vacuum, then similar to the time delay of light traveling from the Sun to the Earth as depicted in FIG. 2A, the respective gravitational pull between two mutually orbiting star-bodies, e.g., A and B, would be subject to a function of time, and of the distance that separates the two star-bodies. A slow gravity velocity or a high orbiting speed would enhance the effect by maximizing theta, the angle between the actual position and the observed, “apparent,” or ‘felt’ position.

Some of the above-referenced papers, incorporated by reference herein, set forth a further discussion on the effects that distance between the gravitational-emitting bodies have.

Some of the above-referenced papers, incorporated by reference herein, set forth mathematical proofs of a calculation of the speed of the reach of the force of gravity, the speed of which is shown to be 0.25% the speed of light (or 400 times slower than the speed of light).

Some of the above-referenced papers, incorporated by reference herein, describe historical thinking about such matters as the speed of the reach of the force of gravity, and theories regarding Dark Matter, which has been theorized as to exist in order to explain discrepancies between the amount of gravity that would be predicted using traditional formulas on the one hand, and empirical evidence on the other hand.

Some of the above-referenced papers, incorporated by reference herein, describe a summary of the speed of the reach of the force of gravity, and theories regarding Dark Matter and Dark Energy.

Some of the above-referenced papers, incorporated by reference herein, explain in more detail the tangential gravitational acceleration and gravitational force vectors as compared to gravitational forces that would be predicted by Newton's Gravity Equation, the way that equation has traditionally been interpreted. In particular, as traditionally interpreted, the “r” used in Newton's Gravity Equation has been the longest possible “r,” namely, the diameter of opposing orbits (see, e.g., elements 10 and 30, e.g., in FIGS. 3 and 4A). As traditionally interpreted, use of the longest possible “r” in Newton's gravity equation results in calculating a lower predicted gravity. The calculation of a lower predicted gravity is consistent with, and supported, the Dark Matter theory and results.

FIG. 3 illustratively depicts two “mutually” orbiting masses, namely, exemplary Mass A at time t₁ 1, and exemplary Mass B at time t₁ 3. An exemplary orbit direction around exemplary orbit 20 is illustratively depicted along lines At₁-At₂ and Bt₁-Bt₂.

As will be understood by someone with ordinary skill in the art, Newton's Laws and Einstein's Law of Relativity assume that gravity travels infinitely fast.

If those assumptions were correct, then as illustratively depicted in FIG. 4B, the distance (illustratively denoted in FIG. 4B as “r”) that would be traveled by gravitational force (denoted as Fga) from exemplary Mass A at time t₁ to Mass B at time t₁ would happen instantaneously, before either of the two masses changed location, and would be equivalent to the diameter (denoted as “d1”, element number 10, in e.g., FIGS. 3 and 4A) of the exemplary orbit 20.

Newton's. Equation for the Force of Gravity is:

Fg=G(m₁m₂)÷r²

In Newton's Force of Gravity Equation, “r” represents the distance between the center of mass of two masses that is traveled by gravity.

Because Newton's Force of Gravity Equation assumed that gravity traveled infinitely fast, the value that would have traditionally been used for the variable “r” would have been the diameter (d1 10) of the orbit 20—the longest possible distance.

Herein, the traditionally-calculated, Newton-assumed gravitational force vector is referred to as “Fga”—see, e.g., element number 35 in FIG. 3.

However, that traditional interpretation of the longer orbit-diameter distance as the value for “r” in Newton's equation did not account for any difference in gravitational pull that would be experienced as a function of distance between the two masses and the speed at which gravitation force travels.

Instead of the longer orbit-diameter distance that was traditionally used as the value for “r” in Newton's Equation in order to calculate a force of gravity (Fg) as between the two exemplary star bodies A and B, a corrected r, referred to herein as “r′,” is used to reflect a shorter distance that results from a finite speed at which the force of gravity travels.

Thus, as depicted in FIG. 3 and explained in more detail below, gravitational force emitted by exemplary star-body A and received by exemplary star-body B, and changes in location of the two mutually orbiting star-bodies A and B around the mutual orbit 20 in the illustrative orbit direction 25, in view of a finite speed at which gravitational force travels, would create certain Force vectors. For example, gravitational force emitted by exemplary star-body A and received by exemplary star-body B, and changes in location of the two mutually orbiting star-bodies A and B around the mutual orbit 20 in the illustrative orbit direction 25, in combination with the finite speed at which gravitational force travels, would create exemplary gravitational Force vector “Fg” 45 along the exemplary gravitational direction line 40 from the exemplary location of exemplary star-body B at time t₂ 4 to the exemplary location of exemplary star-body A at time t₁ 1.

As will also be further discussed below, another Force vector, termed herein, a tangential gravitational acceleration vector, “Va” 60 (see, e.g., FIGS. 3 and 4A-4B) is also created as a result of the gravitational force emitted by exemplary star-body A and received by exemplary star-body B, and as further a result of changes in location of the two mutually orbiting star-bodies A and B around the mutual orbit 20 in the illustrative orbit direction 25 and further, due to the lag created by the finite speed at which gravitational force travels.

Gravitational Force vector “Fg” 45 is created due to a shorter distance value for the “r” in Newton's Gravity Force Equation, namely, the corrected r (“r′,”-element 40, as illustratively depicted in FIG. 4B) that gravity would travel from star-body A to star-body B. That is, the distance between the exemplary location of exemplary star-body B at time t₂ 4 to the exemplary location of exemplary star-body A at time t₁ 1 (the distance d2 of line 40 in FIG. 4A; r′ of line 40 in FIG. 4B) is shorter than the distance between the exemplary location of exemplary star-body B at time t₁ 3 to the exemplary location of exemplary star-body A at time t₁ 1 (the traditional (“r”)) distance d1 of line 10 depicted in FIG. 4A).

As depicted in FIG. 3, and as further depicted in FIG. 4A, the amount of the gravitational force vector Fg 45 will increase as the difference between the two distances (d₁ and d₂) increase. That is, the slower the speed at which gravity travels, the shorter the distance d₂ will be, and the stronger the resulting gravitational force vector Fg 45 will be. That is, due to the speed at which gravitational force travels, Fg 45 is greater than the Newton-predicted force Fga 35. This stronger gravitational force vector Fg 45 provides a force that is the equivalent to the Dark Matter effect, and explains the extra Gravity that Zwicky tried to explain with his Dark Matter theory (see the above-referenced papers, incorporated by reference herein).

In addition to the gravitational force vector Fg 45, another force vector, a tangential acceleration force vector Va 60, is created. The force of the tangential acceleration force vector Va 60 increases in proportion to the sine of angle θ (theta) 80, which is the angle formed between the Newton-assumed gravitational force vector “Fga” 35 and the gravitational force vector Fg 45.

As depicted in FIG. 4B, the slower the speed at which gravitational force travels, the larger the angle θ (theta) 80 (as depicted in FIGS. 4A and 4B) becomes, and therefore, the greater the force of the tangential acceleration force vector Va 60 becomes (see element 95 depicted in FIG. 4B).

The increase in the force of gravity due to a decrease in the value used for “r” in Newton's equation will rise proportionally with 1/r². This increase in the force of gravity explains greater gravity being exhibited than is predicted using Newton's equations as that equation has traditionally been interpreted. The above-given explanation unravels the Dark Matter conundrum of accelerated acceleration and of more-than-expected exhibited gravity but without needing the previously-postulated, ghostly “Dark Matter.”

The above-given explanation does not contradict Newton's Law, but rather corrects the distance that should be used for the “r” in Newton's Law. The above-given explanation may seem to contradict one of the “known” laws of thermodynamics about the conservation of energy. However, it has been the opinion of some scientists that “[t]here is no proof of any the laws of thermodynamics, they are based solely on experience.” Moreover, since the discovery of the Dark Energy in 1998, mankind's long experience and acceptance of the conservation of energy and momentum is in conflict with empirical results.

The gravity acceleration vector (Va 60 depicted in, e.g., FIGS. 3 and 4A-4B) further explains the relatively recently (1998) discovered accelerating force, “Dark Energy,” that is propelling the outermost stars away from the galactic center.

As previously mentioned above, the gravitational and tangential gravitational acceleration forces in the universe exist on such an immense scale that a way to harness these forces would be extremely difficult with today's technology.

However, as described further below, a magnetic force vector and a tangential magnetic acceleration force vector, analogous to the gravitational force vector and the tangential gravitational acceleration vector described above, can be created, and harnessed, in the realm of electromagnetism.

Unlike gravity (which may be too immense and too vast to harness), and the strong and weak forces (which may be too small to harness), magnetism and electromagnetism are forces that are controllable and useable at human scales. Further, as explained below, magnetism demonstrates forces and properties analogous to those explained above regarding gravitational forces and properties.

Notably, even the equations for gravitational force and magnetic force demonstrate an analogous relationship between gravity and magnetism:

The equation for the force of gravity is:

F=G*(m1*m2)/r²

Analogous to the equation for the force of gravity, the equation for the force of magnetism (Coulomb's Law) in its most basic form, is:

F=ke*(q1*q2)/r²

In both cases the force, whether it is gravitational or magnetic, is inversely proportional to the square of the distance between (sometimes more, depending on the magnet shape), and directionally proportional to the product of either the masses (gravity), or the charges (magnetism; q1,q2).

Using magnets, as described further below, it would be possible to produce a tangential magnetic force acceleration vector that replicates properties of the tangential gravitational acceleration vector or “Magnetic Dark Energy” previously described above; it would be possible to then harness that tangential magnetic force acceleration vector (Magnetic Dark Energy) to produce clean energy.

The Physics of Newtonian Relativity

FIG. 4C is an illustrative graphic representation of the physics of Newtonian Relativity. As explained further below, among other things, FIG. 4C graphically represents the introduction of orientation as an additional relativistic effect.

As will be understood by someone with ordinary skill in the art, it has been traditionally recognized that height, width and time information about a first body of matter 410 that is traveling around an orbit 415 around a central point 420 (massless or otherwise) will travel at the speed of light; that the height, width and time information traveling at the speed of light would be perceived by a second body of matter 430, also traveling around the mutual orbit 415; that such height, width and time information traveling at the speed of light will all be “dilated” (see element 410′) due to a “lag” time that occurs due to the time that it takes the information traveling via light to reach the second body of matter 430 with respect to the speed of the orbit travel of the first 410 and second 430 bodies of matter.

FIG. 4C graphically represents that, in addition to dilation of height, width and time information, orientation (see the illustrative orientation of element 410′ compared to the illustrative orientation of element 410) of the above-mentioned first body of matter 410 is also dilated due to the “lag” time that occurs due to the time that it takes the orientation information traveling via light to reach the second body of matter 430 with respect to the speed of the orbit travel of the first 410 and second 430 bodies of matter.

As discussed further herein, gravity is similarly dilated, because gravity travels at a finite constant speed (c/857, where “c” is the speed of light), rather than infinitely fast as has previously been theorized.

But there are some “corrections” that must be considered in order to accurately calculate the gravitational force emitted by the first body of matter 410 (and 410′) and “felt” by the second body of matter 430 when the velocity of the force of gravity (V_{fg}) is less than infinitely fast.

One “correction” that must be considered in order to accurately calculate gravitational force is the distribution of dark energy. Dark energy, and the dark matter effect, increase in view of the above-described r′_{(c/}857), as compared to the traditionally used r_{(infinity)}. But the dark energy component should be further sub-divided in order to account for the distribution of dark energy. For example, some dark energy that is created contributes to the centrifugal force that occurs due to the orbit's curvature.

Another “correction” that must be considered in order to accurately calculate gravitational force is related to what is referred to as the Poynting-Robertson effect. As will be understood by someone with ordinary skill in the art, the Poynting-Robertson effect is related to radiation pressure tangential to a dust grain's motion as it orbits a star. In particular, radiation from the star causes a dust grain that is orbiting the star to lose angular momentum relative to its orbit around the star. The result of this effect is that a dust grain that is small enough to be affected by the radiation-caused drag, but too large to be blown away by the star's radiation pressure, will slowly spiral into the star.

This second “correction” that must be considered is a dilation of the Poynting-Robertson effect in a manner similar to the dilation of gravity as elsewhere described herein, except that the Poynting-Robertson effect should be dilated according to r_{(c)} (the force propagation according to the speed of light). That is, the Poynting-Robertson effect should be considered along the line using r′_{(c)}; the Poynting-Robertson effect is a repulsive force arriving at a lesser angle than the gravitational force, because of light's greater speed.

### SUMMARY OF THE INVENTION

Exemplary embodiments of the present invention would provide ultra high-speed spinning magnet(s) in an ultra-low friction environment that would generate clean power when spinning above a certain RPM (Revolutions Per Minute).

The exemplary certain RPM would be analogous to an ignition temperature when lighting a log on fire. That is, in lighting a log, energy is first added in the form of heat, and then at the right temperature, the log catches fire and dumps its stored heat. Another analogy is that Fusion power needs an enormously high, controlled initial temperature to start the process of fusion power generation—something that seems to still elude physicists. It seems that in order to produce power, one needs to spend power first on something, like heat in the log analogy. In the case of an exemplary embodiment of the present invention, spinning friction would be reduced to a point lower than the Dark Energy created at high enough RPM's. As the speed of rotation increases, the Dark Energy force increases exponentially. When this Dark Energy force exceeds the amount of rotational friction—you have a motor.

In some exemplary embodiments of the present invention, an initial drive motor would be used to start rotation of a rotor to which alternating opposing magnetic pole magnets would be mounted. The job of the initial drive motor would be to drive the revolution of the rotor up to a high speed (a certain number of revolutions per minute (“RPMs”), as discussed further below, preferably, in an ultra-low-friction environment, so that the magnets would be rotating so fast around a mutual orbit, that, as between two adjacent, alternating opposing poles magnets, the lead magnet would emit a magnetic force that would attract the adjacent following magnet to a location that had been occupied by the lead magnet prior to the lead magnet having been rotated away from that location.

Some exemplary embodiments of the present invention would provide an apparatus that would produce a magnetic acceleration force, said apparatus comprising: a rotor that would orbit opposing-pole-facing magnet(s), generating a tangential [“Dark Energy”] magnetic acceleration force; and a wire coil that would receive electrical energy from the rotor magnets traveling alongside it because the tangential [“Dark Energy”] magnetic acceleration force that is created by the rotor that is orbiting the two opposing-pole-facing magnets will accelerate them and will therefore produce said electrical energy for power generation over the twin hurdles of environmental friction and the drag exerted on the magnets by the coil's electrical generation. Some friction may be helpful to keep the magnets from spinning out of control. That is, in a hypothetical non-friction environment, the magnets would quickly spin out of control. Notably, there is no known instance of a stable magnetic orbit ever being demonstrated.

As will be understood by someone with ordinary skill in the art, there would be many possible configurations of magnets, and rotors, that could be rotated at ultra-high-speeds (i.e., spinning above a certain RPM (Revolutions Per Minute) in an ultra-low friction environment that could be used to generate clean power in manners described further below. This application presents a number of alternative exemplary embodiments; they are illustrative and non-limiting.

For example, some exemplary embodiments would provide an exemplary apparatus that would produce energy due, at least in part, to an attraction of a first opposing-magnetic-pole of a “following” magnet that is orbiting around an orbit, to an opposite magnetic force emitted by a second opposing-magnetic-pole of a “leading” magnet, that is mutually orbiting around said orbit, said first-opposing-magnetic-pole of said following magnet magnetically attracted to said opposite magnetic force emitted by said second opposing-magnetic-pole of said leading magnet according to a tangential magnetic acceleration force vector generated by said mutual orbiting of said leading magnet and said following magnet around said orbit. In one such exemplary, the exemplary embodiment would further comprise: an exemplary initial drive motor; and an exemplary rotor; the exemplary rotor would be attached at a first portion to the exemplary initial drive motor; the exemplary rotor would be attached at a second portion to an exemplary rotational mount that would present an exemplary plurality of opposing-magnetic-poles of a plurality of magnets such that each magnetic pole of said plurality of opposing-magnetic-poles would alternate in opposing magnetic force as compared to a preceding magnetic force of an opposing-magnetic-pole that precedes said magnetic pole around said orbit and as compared to a following magnetic force of an opposing-magnetic-pole that follows said magnetic pole around said orbit. In one such exemplary embodiment, the exemplary initial drive motor would initially rotate the exemplary rotor, which would, in turn, rotate the exemplary rotational mount, thereby mutually orbiting the exemplary plurality of opposing-magnetic-poles of said plurality of magnets.

In one such exemplary embodiment, the exemplary initial drive motor would initially rotate the exemplary rotor, and the exemplary rotor, in turn, would rotate the exemplary rotational mount, thereby mutually orbiting said plurality of opposing-magnetic-poles of said plurality of magnets around an axis that would comprise the central axis of the exemplary rotor; rotation of the exemplary rotor and exemplary rotational mount would be at a high speed in a low-friction environment such that the magnetic force of each preceding magnetic pole would emit an opposing magnetic force that would attract an alternate opposing magnetic pole of the magnetic pole according to the above-mentioned tangential magnetic acceleration force vector.

In one such exemplary embodiment, the exemplary apparatus would further comprise an exemplary wire coil that would freely surround the exemplary rotational mount; the exemplary wire coil would receive electrical energy created when the opposing magnetic force of each preceding magnetic pole attracts said alternate opposing magnetic pole according to said tangential magnetic acceleration force vector, thereby contributing to a further rotation of said rotational mount, said wire coil transferring said electrical energy to at least one power generator, said power generation generating power. In one such exemplary embodiment, the exemplary apparatus would further comprise an exemplary stator; and the exemplary wire coil would be mounted to an interior of the exemplary stator so that the wire coil freely surrounds the exemplary rotational mount.

### BRIEF DESCRIPTION OF THE DRAWINGS

These and other features of the present invention are more fully set forth in the following description of exemplary embodiments of the invention. The description is presented with reference to the accompanying drawings in which:

FIG. 1 is a graphic chart plotting along a line labelled “A” expected star velocities at specific distances from the galactic center according to Kepler's equation for orbital velocities, and further plotting along a line labelled “B” the actual observed speed of stars as plotted against their distance from the galactic center;

FIG. 2A illustratively depicts an exemplary changing location of the earth during an exemplary eight minutes time of travel in the Earth's orbit around the Sun, and further illustratively depicts light emitted by the Sun at time t₁;

FIG. 2B illustratively depicts of a person on Earth viewing at time t₂ the light emitted by the Sun at time t₁;

FIGS. 3, 4A and 4B illustratively depicts Star-Body A, orbiting around a mutual orbit with Star Body B, at time t₁ emitting a gravitational force that travels to reach Star-Body B at time t₂;

FIG. 4C is an illustrative graphic representation of the physics of Newtonian Relativity;

FIG. 5A illustratively depicts an exemplary embodiment that would mutually orbit two opposing-pole magnets;

FIGS. 5B through 5D illustratively depict exemplary magnetic forces and magnetic force vectors that would be created in a further exemplary embodiment that would mutually orbit a plurality of opposing-pole magnets;

FIG. 6 illustratively depicts a still further alternative exemplary embodiment that would mutually orbit two opposing-pole magnets;

FIGS. 7, 8A and 8B illustratively depict multiple alternative magnet orientations for exemplary embodiments of the present invention;

FIG. 9A illustratively depicts an exemplary embodiment of the present invention;

FIG. 9B illustratively depicts exemplary geometric perspectives of exemplary energy effects generated by an exemplary embodiment of the present invention;

FIG. 10A illustratively depicts an alternative exemplary embodiment of the present invention;

FIG. 10B illustratively depicts an exemplary multiple-magnet configuration for providing an exemplary “long” magnet” in an alternative exemplary embodiment of the present invention;

FIG. 10C illustratively depicts an exemplary multiple-magnet “long” magnet alternative exemplary embodiment of the present invention;

FIGS. 11 and 12 illustratively depict alternative exemplary ways to “tether” magnets together for exemplary embodiments of the present invention;

FIG. 13 illustratively depicts an exemplary rotor with magnetic inserts in an exemplary embodiment of the present invention;

FIG. 14 illustratively depicts the relationships between increases in RPMs, the magnetic acceleration force, and friction loss;

FIG. 15 illustratively depicts an exemplary axle feature of a yet further alternative exemplary embodiment of the present invention in which opposing magnetic poles of two, flat-sided, rod magnets would be counter-posed to form a rotatable axle;

FIG. 16 illustratively depicts a further alternative exemplary laterally-magnetized axle embodiment of the present invention; and

FIG. 17 illustratively depicts a still further alternative exemplary embodiment of the present invention in which opposing magnetic poles of two, cylindrical rod-shaped magnets would be counter-posed and enclosed within an exemplary cylindrical axle casing to form a rotatable axle.

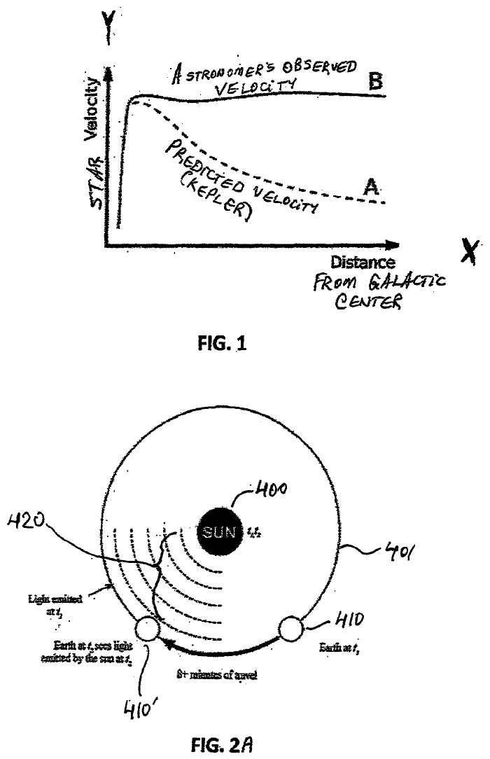

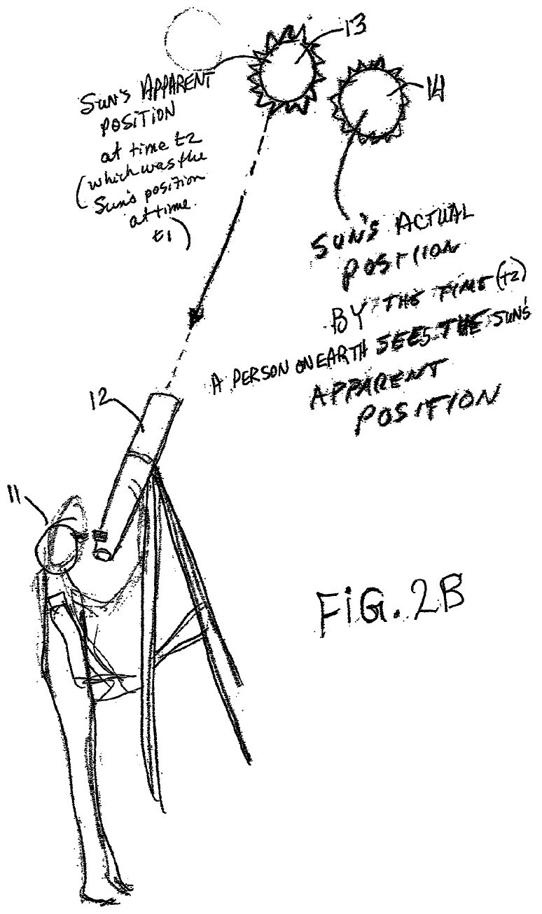

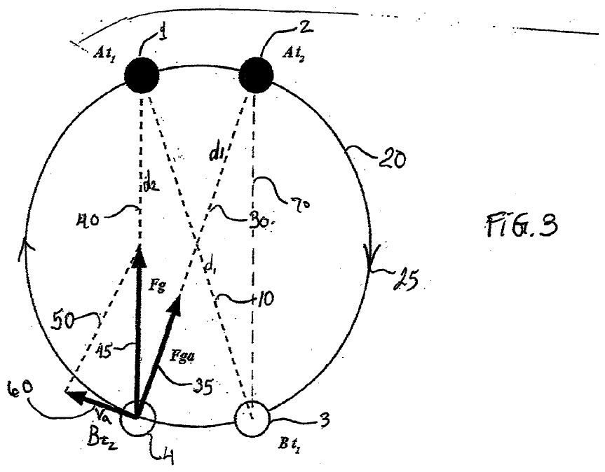

### DETAILED DESCRIPTION OF THE INVENTION

In some exemplary embodiments, two magnetic opposite-poles could be rotated around a mutual orbit to produce a magnetic force acceleration vector that replicates properties of the gravitational acceleration vector previously described above. However, because the magnetic dipoles do not cancel out this force, then in some exemplary embodiments, it would be possible to rotate a single magnet such that its opposing poles could be then treated as two single pole points, a north and a south. In yet other exemplary embodiments described further below, a laterally-magnetized axle would be spun at ultra-high speeds, producing ultra-high RPMs (Revolutions per Minute) in order to produce a magnetic force acceleration vector.

In some exemplary embodiments, the electromagnetic coil can be anywhere near magnets moving relative to it.

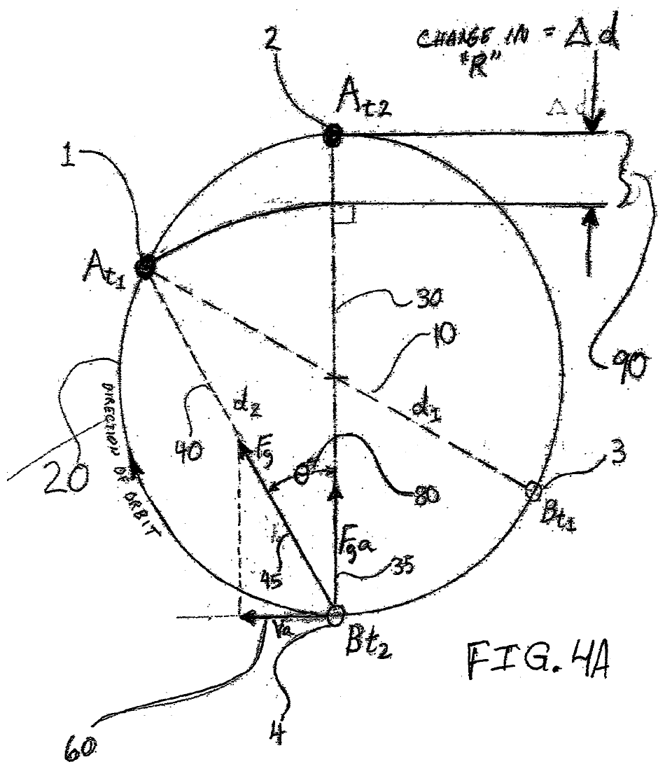

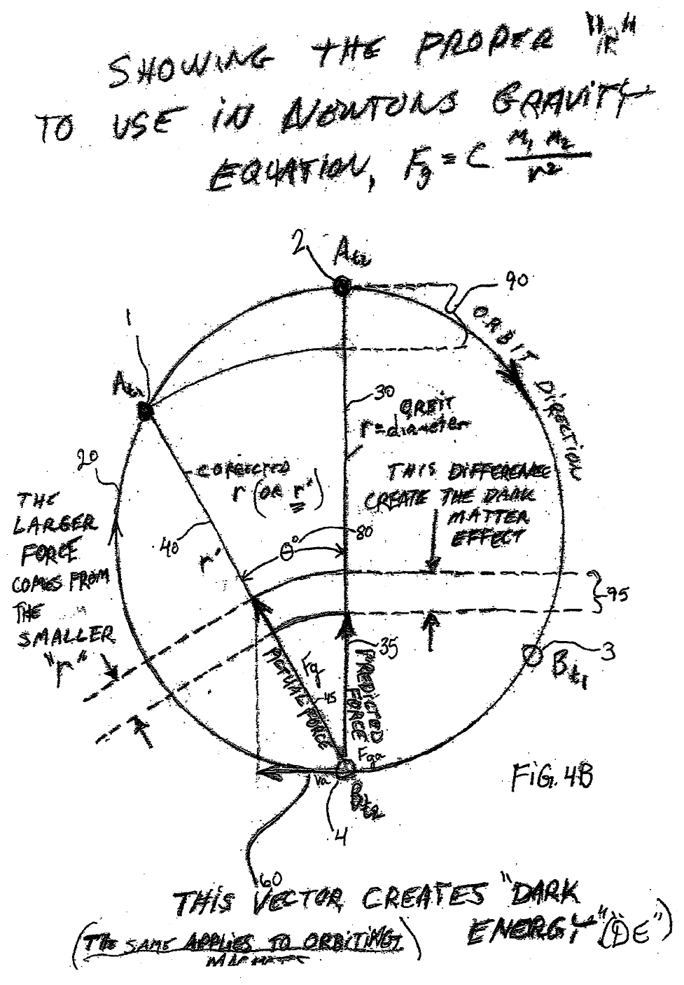

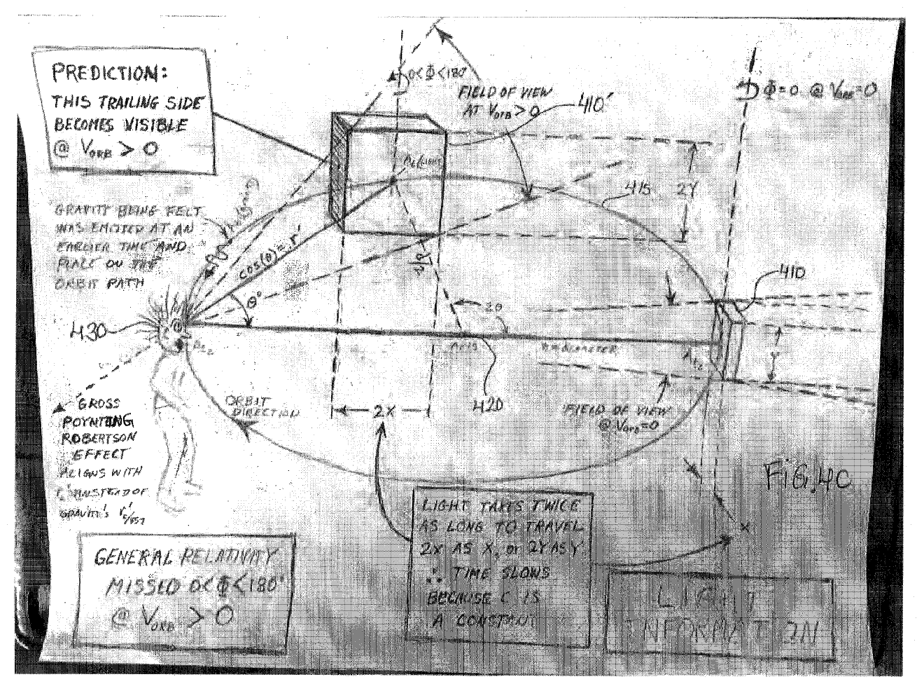

The larger the difference between d₁ and d₂ (see, e.g., element nos. 30 and 40 depicted in FIGS. 3 and 4A), the larger the angle theta (θ; see, e.g., element no. 80 in FIG. 4A) will be. The larger the angle theta (θ; see, e.g., element no. 80 in FIG. 4A), the larger the dark forces (Dark Matter effect and Dark Energy forces) will be.

Any two magnets with a North Pole close to the other magnet's South Pole with the orbital axis separating them will work. Multiple magnets, and including electromagnets, would also work. Or, as mentioned above, a single magnet with opposing poles could be rotated at ultra-high speed, producing ultra-high RPMs.

Because the attractive force of magnets drop dramatically with distance, one can calculate the attractive force of the two closest ends and ignore the forces generated by the opposite ends (poles) since they are minimal in comparison. Magnets could be designed to enhance and magnify this phenomenon.

One possible exemplary embodiment would be a greatly miniaturized version doing the same thing as described above, but at an atomic or subatomic scale, creating a continuous, very small, either a kinetic force or an electrical charge.

Exemplary embodiments would create the magnetic acceleration vector at a human scale so that it can be harnessed. In order to understand the potential for energy that could be generated by harnessing the magnetic acceleration vector, the following hypothetical “maximum” calculations are provided.

Assuming for the moment (for illustrative purposes and the sake of argument only) that the speed of the reach of gravitational and magnetic forces travel is the speed of light (“C”), a hypothetical “maximum” magnetic acceleration vector would occur when two mutually orbiting magnets are traveling around their mutual orbit very close to the speed of light—at that speed, the theta (see, e.g. theta angle 80 depicted in FIG. 4A) would be maximized since the twirling magnets cannot exceed C (the speed of light).

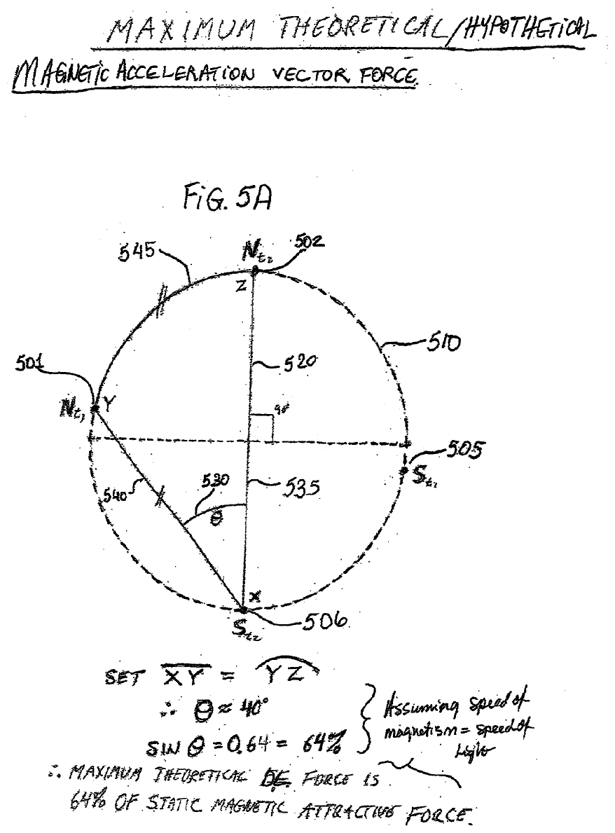

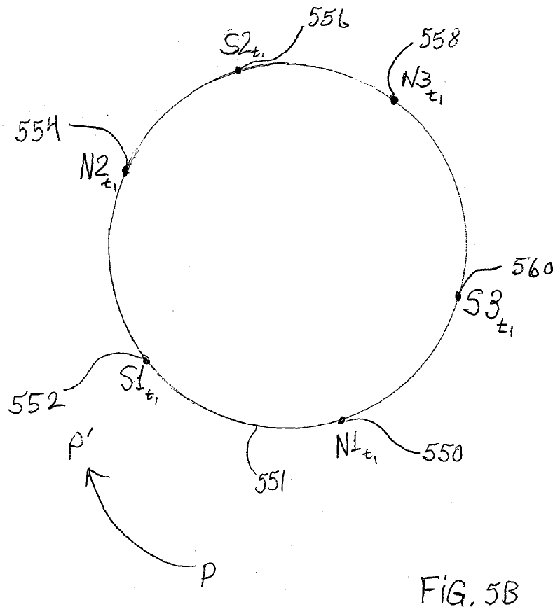

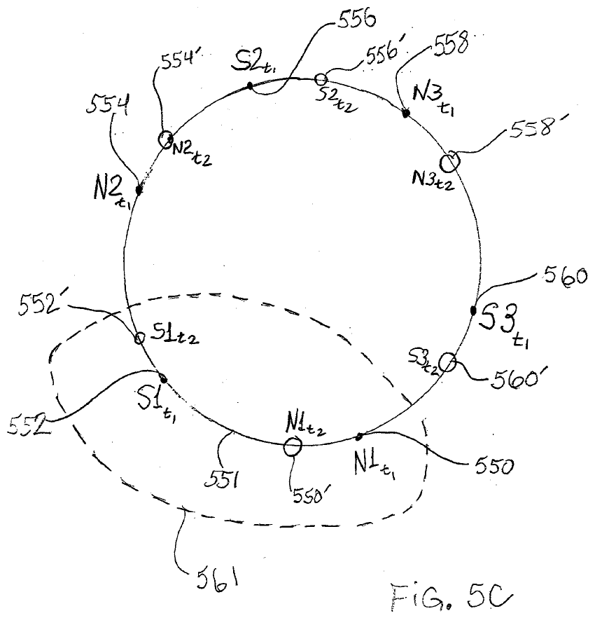

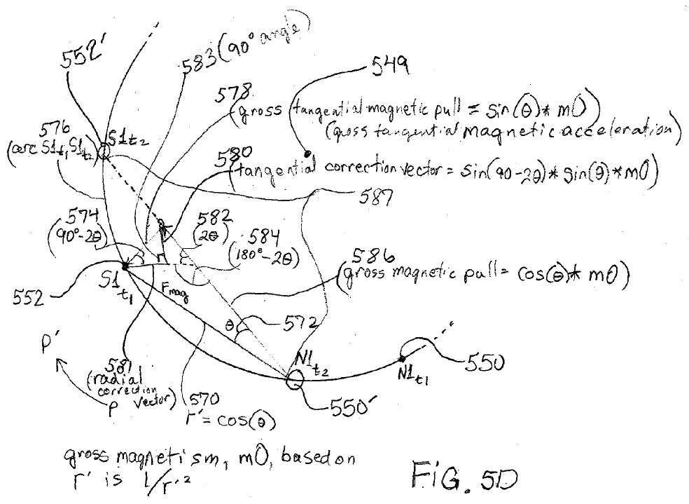

FIG. 5A is an illustrative graphic depiction of a North Pole of a first magnet (which will sometimes be referred to herein as Magnet A) and the South Pole of a second magnet (which will sometimes be referred to herein as Magnet B) traveling around a mutual orbit 510. In particular, FIG. 5A depicts a location of the North Pole of Magnet A at time t₁ 501 (denoted on FIG. 5A as Nₜ₁ and referred to in calculations and equations herein below as “Y”) and a location of the South Pole of Magnet B at time t₁ 505 (denoted on FIG. 5A as Sₜ₁). FIG. 5A depicts that at a later time, e.g., time t₂, the North Pole of Magnet A has traveled around the mutual orbit 510 to a location denoted on FIG. 5A as Nₜ₂502 (and referred to in calculations and equations hereinbelow as “Z”), and the South Pole of Magnet B has traveled around the mutual orbit 510 to a location denoted on FIG. 5A as Sₜ₂ 506 (and referred to in calculations and equations herein below as “X”).

The distance for light to travel from the North Pole of Magnet A at time 1 (denoted on FIG. 5A as Nₜ₁ and referred to in calculations and equations herein below as “Y”) to the South Pole of Magnet B at time 2 (denoted on FIG. 5A as Sₜ₂ 506 and referred to in calculations and equations herein below as “X”) in a straight line 540 will approximate the distance 545 that the North Pole of Magnet A travels around the mutual orbit 510 from time 1 to time 2 (to a location denoted on FIG. 5A as Nₜ₂ 502 and referred to in calculations and equations herein below as “Z”).

Setting these two distances (540 and 545) equal to each other (i.e., set the distance between X and Y to be equal to the distance between Y and Z), then the (theta) angle θ 530 would be roughly equal to 40 degrees.

The sine of the (theta) angle θ 530 at 40 degrees is 0.64 or approximately 64% of the original force between the two Magnets A and B (i.e., between the North Pole of Magnet A and the South Pole of Magnet B). Therefore, two magnets with a normal attractive force of 300 pounds, orbiting at close to the speed of light would each feel an acceleration of approximately (0.64*300 pounds), i.e., approximately 193 pounds. That acceleration represents roughly 6 times the force of gravity on the surface of the Earth.

As previously mentioned above, even though FIG. 5A depicts and is described with respect to two separate magnets, it would be possible in some exemplary embodiments to use a single magnet, rather than two separate magnets. Yet further, as mentioned above, and as further described below, in some exemplary embodiments, a laterally-magnetized axle would be rotated at ultra-high speeds.

Presently, setting two magnets orbiting at the speed of light may not be practicable. However, the above calculation demonstrates a hypothetical upper limit of considerable power, assuming for illustrative purposes and the sake of argument only that the speed of the reach of magnetic force (and gravity) is approximately equivalent to the speed of light. Notably, although stars must be held in mutual orbit by gravity, magnets are under no such constraint. Rather, it would be possible to tether two magnets' poles together and rotate them far faster than their natural orbiting velocity and in so doing, raise the amount of force mutually generated through their ‘created’ Dark Energy magnetic acceleration vector.

As was previously mentioned above, for much of the discussion in this patent application, the speed of the reach of the force of gravity has been assumed, for the sake of illustration and for the sake of argument only, to be the long-accepted speed equivalent to the speed of light. However, as further explained below, and as explained in more detail in the above-referenced papers, incorporated by reference herein, the speed of the reach of the force of gravity is actually much slower (860 times slower) than the speed of light (1.1% of the speed of light). In particular, the above-referenced papers, incorporated by reference herein, set forth mathematical proofs and calculations of the speed of the reach of the force of gravity.

In brief summary, the proof and calculations of the speed of the reach of the force of gravity (and analogously, the speed of magnetism, calculations for which are described further below) set forth in the above-referenced papers, incorporated by reference herein, depict two illustrative star bodies (see, e.g., FIG. 4B, illustrative Star Body A (at time 1 (At1) 1 and at time 2 (At2) 2) and illustrative Star Body B (at time 1 (Bt₁) 3 and at time 2 (Bt₂) 4) that are in an exemplary, mutual, opposing orbit 20. A distance “r” is the orbit diameter 30 (as depicted in FIG. 4B). When the traditionally accepted “r” is used in Newton's Gravity Equation, the Force of Gravity (Fg)=C*(M1*M2)/r². However, scientists/astronomers tell us that there is actually 5.6 times more gravitational force in the universe than would be predicted using Newton's Gravity Equation, using the masses of visible matter only. So, because of science's adherence to the long-held interpretation of Newton's Gravity Equation, scientists have propounded the existence of “Dark Matter,” which cannot be seen or touched, but which, scientists have propounded, accounts for the otherwise heretofore unexplained 5.6 times more gravitational force.

The above-referenced papers, incorporated by reference herein, use the calculation of the 5.6 times greater gravitational force to calculate the speed of the reach of gravity (and analogously, the speed of the reach of magnetism). In particular, as set forth in the above-referenced papers, incorporated by reference herein, the ratio of Dark MatterNisible Matter is set equal to 5.6 for galaxies that we have studied. According to the mathematical proof and calculations set forth in the above-referenced papers, incorporated by reference herein, the “r” in Newton's Gravity Equation, is reduced to solve for 5.6 times as much gravity as provided by Newton's Gravity Equation. As a result, r′ is calculated to equal approximately 0.42, which represents the real distance at which Star Body At₁ was from Star Body Bt₂ when gravity was emitted by Star Body At₁ at a high enough orbiting speed. For purposes of the proof, the position of Star Body A is assumed to be somewhere along its orbit path (see, e.g., element 20 in FIG. 4B).

With illustrative reference to FIG. 4B, the proof and calculations set forth in the above-referenced papers, incorporated by reference herein, then solve for the angle theta (θ; see element 80 in FIG. 4B), which is the angle at which Gravity from At₁ tugs at Bt₂. In particular, cos (θ)=r′; θ=65 degrees.

The angle theta (see θ; element 80 in FIG. 4B) defines the ratio between Dark Energy and “Dark” and Visible Matter. As further set forth in the above-referenced papers, incorporated by reference herein, solving for the proportion of each force as a percentage of the total gravitational force results in Dark Energy Force representing approximately 68% of the total gravitational force. That calculation is consistent with the empirical results of various astronomers that calculate that Dark Energy represents approximately 68.3% of the energy of the Universe.

The calculations set forth in the above-referenced papers, incorporated by reference herein, calculate that the theoretical “Dark Matter” represents approximately 26% of the whole; Visible Matter represents approximately 5.7% of the whole. The calculations set forth in the above-referenced papers, incorporated by reference herein, further calculate the value of V_{Fg} to be equal to C/860, or approximately 1.1% of C (i.e., 1.1% of the speed of light).

Notably, as further described in the above-referenced papers, incorporated by reference herein, at the calculated 0.25% of C (i.e., 0.25% of the speed of light), the gravitational (and magnetic) acceleration force is approximately twice as strong as when the speed of gravity (and magnetism) is assumed to travel at the speed of light.

Further, it is notable that the gravity that illustrative Star Body Bt₂ receives pulls it both in toward gravity-emitting body A at time t₁ (Fg; see element 45 as depicted in FIG. 4B) and also “forward” (tangentially to its orbit; Va; see element 60 as depicted in FIG. 4B).

It is remarkable that, when gravity-emitting (or magnetism-emitting) bodies travel around a mutual orbit, the mutually-emitted forces (gravity, or magnetism, as the case may be) in combination with the speed of the reach of those forces, and the distance that separates the respective force-emitting bodies, change the previously-accepted understanding and interpretation of the laws of physics.

Because Dark Energy can now, as described herein and in the above-referenced papers, incorporated by reference herein, be explained as a time lag of gravity between two mutually-orbiting masses (or alternatively, as a time lag of magnetism between two mutually-orbiting, opposing-pole magnets), there is no theoretical need for “Dark Matter.”

Returning to the description of exemplary magnetic Dark Energy generating embodiments, a possible limiting factor may be the strength of the materials tethering the two mutually orbiting (spinning) magnet poles. The mutual orbit of the two tethered magnets would depend on the strength of the material tethering them together and keeping them from flying apart at high speeds of orbit, due to (depending on how the “tethering” is embodied), centrifugal and/or centripetal forces.

There are presently, motors, such as micro gas turbines, that are capable of 500,000 revolutions per minute (RPM) and an active magnetic bearing capable of spinning objects 4.5 million RPM. But in one exemplary embodiment, an energy generating motor would be made that would orbit two permanent magnets at 200,000 RPM. The exemplary magnets in this particular illustrative exemplary embodiment would comprise, for example, two strong N52 magnets that exhibit a force of 500 pounds when their opposing poles are maintained at a distance of 2 centimeters (cm) from each other. In order to calculate the approximate force that would be generated, we would first solve for the (theta) angle θ 530, illustratively depicted in FIG. 5A.

Using the motor mentioned above, Magnet A would travel at 200,000 RPM; the two magnets are to orbit with a distance of only 2 cm between them, so the radius of the orbit (“r”) would be 1 cm. So the speed at which Magnet A would travel around the orbit (element 510 illustratively depicted in FIG. 5A) would be: 200000 RPM*2*“pi”*r*minute/60 sec equals approximately 210 meters per second around the mutual orbit, e.g., 510, as illustratively depicted in FIG. 5A.

As previously mentioned above, the speed of light is also considered by some long-held scientific theories to be the speed at which massless particles and changes of associated fields, including gravitational waves (and magnetism), travel in a vacuum. Therefore, for illustrative purposes, the speed of light (denoted as “C”) will be used as the speed at which the magnetic information travels from Magnet A to Magnet B. The speed of light (C) is 300,000,000 meters/second. Because in the illustrative exemplary embodiment, the two magnets are 2 cm from each other, then the travel time for light between them is therefore approximately 0.02/300000000 sec, which is 6.6*10\hat{ }−11 sec.

As was calculated above, the two exemplary magnets would hypothetically be traveling approximately 210 meters/sec. Therefore, during the time (6.6*10\hat{ }−11 sec) that it takes light from one magnet to reach the other magnet, the two magnets travel around the mutual orbit (e.g., element 510 illustratively depicted in FIG. 5A) approximately 210 meters/sec*(6.6*10\hat{ }−11) sec, which equals approximately 1.4*10\hat{ }−8 meters traveled during that time.

Assuming a frictionless environment, the magnetic acceleration force vector is approximately equal to the magnetic force between the two magnets (500 pounds) multiplied by the distance traveled (1.4*10\hat{ }−8 meters) during the time that it takes light to travel the diameter of the orbit (2 cm (0.02 meters) divided by the diameter of the orbit (2 cm (0.02 meters)), i.e., (500 lbs*1.4*10\hat{ }−8)/0.02=3.5*10\hat{ }−4 or about 3.5 ten thousandths of a pound, or 0.00035 pounds of magnetic force on each pole.

Additionally, there would be an additional gravitational acceleration vector force working alongside the one created by magnetism although it would typically be orders of magnitude smaller.

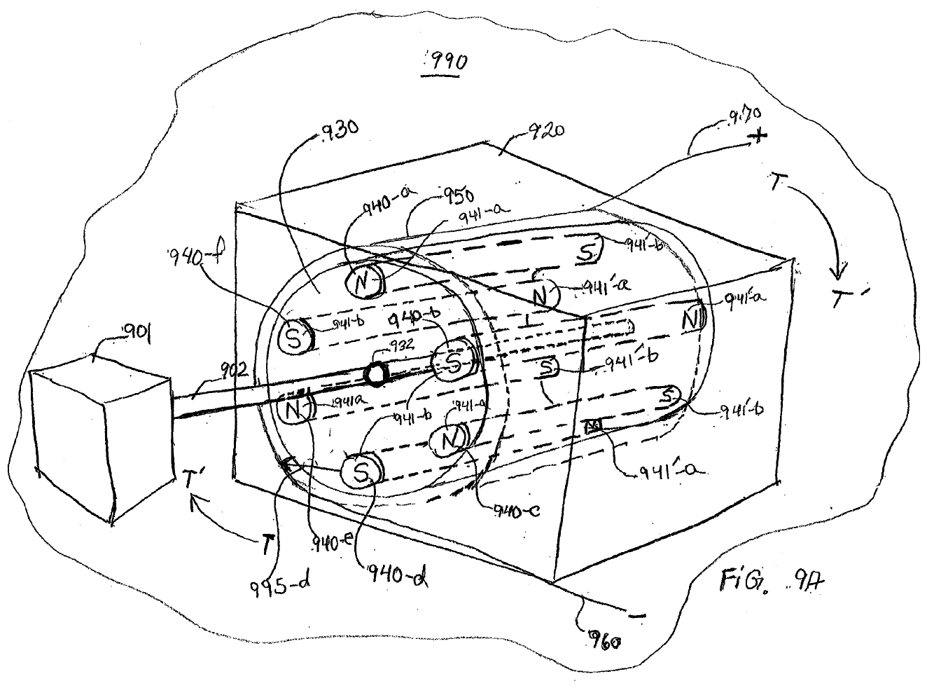

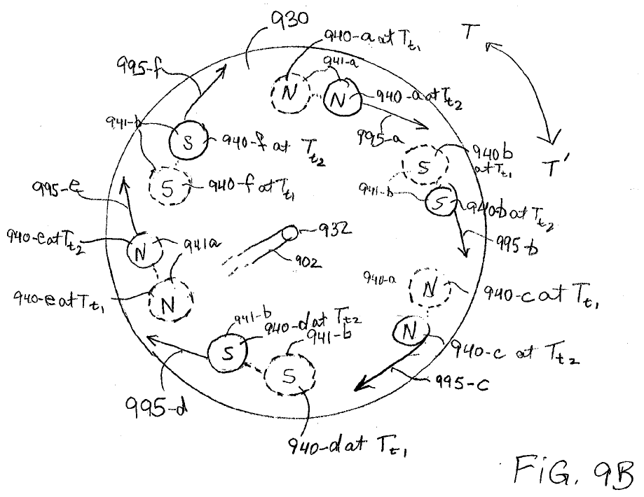

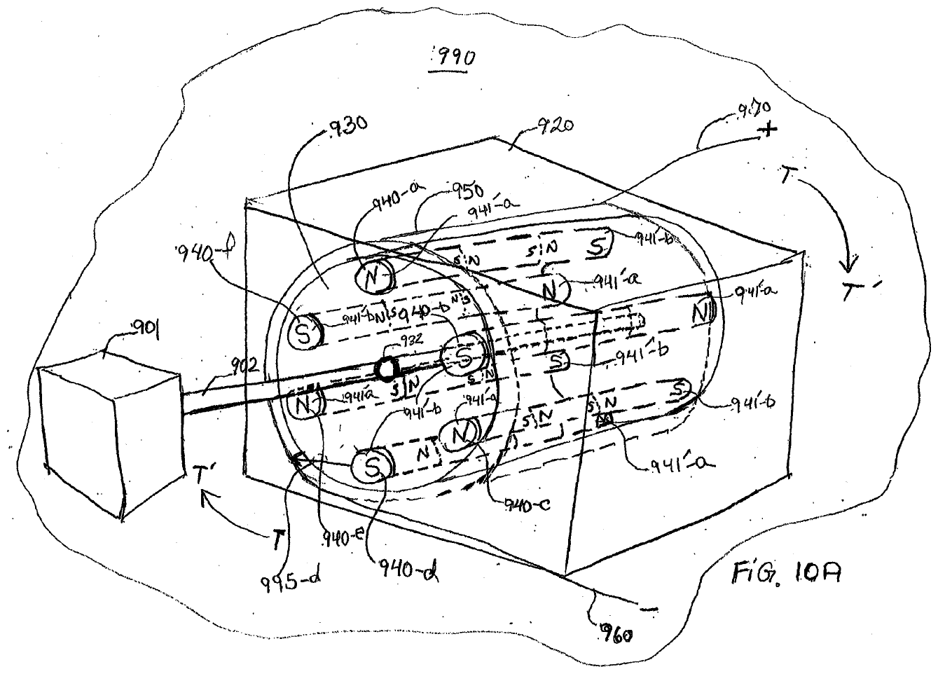

As an alternative to mutually orbiting just two opposing-pole magnets, some of the exemplary embodiments described herein illustratively depict a plurality of alternating opposing magnetic poles mounted into an exemplary rotor, or otherwise tethered together, so that they can be rotated around a mutual orbit (such as about a rotating axle). See for example, exemplary embodiments depicted in FIGS. 9A and 9B. As will be understood by someone with ordinary skill in the art, the magnetic forces and force vectors that would be generated by mutually orbiting a plurality of alternating opposing magnetic poles such as depicted in FIGS. 9A and 9B would be similar to the magnetic forces and force vectors that would be generated when orbiting two, diametrically opposed magnets around the same orbit.

FIGS. 5B through 5D illustratively depict exemplary magnetic forces and magnetic force vectors that would be created in a further exemplary embodiment that would mutually orbit a plurality of opposing-pole magnets. FIG. 5B illustratively depicts at Time “t₁”, alternating opposing-pole magnets (North Magnetic Pole magnets 550, 554, and 558′; South Magnetic Pole magnets 552, 556, and 560) mutually orbiting exemplary orbit 551 in the orbital direction denoted by line P-P′. FIG. 5C illustratively depicts the same alternating opposing-pole magnets at both Time “t₁” (North Magnetic Pole magnets 550, 554, and 558; South Magnetic Pole magnets 552, 556, and 560) and at Time “t₂” (North Magnetic Pole magnets 550′, 554′, and 558′; and South Magnetic Pole magnets 552′, 556′, and 560′).

In FIG. 5C, a portion of exemplary orbit 551 is encircled with dashed line 561. Dashed line 561 encircles an exemplary portion of exemplary orbit 551 where North Pole magnet 550, 550′ (N1) and South Pole magnet 552, 552′ (S1) are located at both Times t₁ and t₂ respectively.

In FIG. 5D, the portion of exemplary orbit 551 marked in FIG. 5C within dashed line 561 is shown in an expanded view with graphically illustrated geometric representations of magnetic relationships and forces between exemplary North Pole magnet 550 (N1 at Time t1), 550′ (N1 at Time t2) and exemplary South Pole magnet 552 (S1 at Time t1), 552′ (S1 at Time t2).

As will be understood by someone with ordinary skill in the art, in a plurality-of-magnets-orbiting embodiment, as the velocity at which the mutually orbiting magnets orbit increases, the magnets that are closest to each other will exert the strongest magnetic force on each other; one magnet will “lead” a “follower” (the closes magnet following the first magnet around the orbit) magnet; the forces between a “lead” magnet and a “follower” magnet will “swamp” the forces by the other magnets mutually orbiting the same orbit. Therefore, for purposes of discussing the magnetic forces in a plurality-of-magnets-orbiting embodiment, focus will be given to the forces between a “lead” magnet and a “follower” magnet; the other forces by the other magnets, although present, will not be discussed.

Returning with reference to FIG. 5D, in view of the above-mentioned focus on the forces between a “lead” magnet and an opposing magnetic pole of a “follower” magnet, the following discussion will focus on forces between an exemplary “lead” magnet (e.g., S1 at Time t₁ 552 and S1 at Time t₂ 552′) and an exemplary opposing magnetic pole of a “follower” magnet (e.g., N1 at Time t₁ 550 and N1 at Time t₂ 550′),

With the understanding that gravity travels at the approximate (constant) speed of c/857, FIG. 5D shows r′ 570 as the dilated distance 587 (i.e, the apparent distance from the perspective of the follower magnet N1 at Time t₂ 550′) between the position of the “follower” magnet N1 at Time t₂ 550′ and the position of the “lead” magnet S1 at Time t₁ 552.

FIG. 5D shows the angle theta (8) 572 as the angle formed between the graphic representation of the dilated distance 570 between the position of the “follower” magnet N1 at Time t₂ 550′ and the dilated position of the “lead” magnet S1 at Time t₁ 552, and the graphic representation 587 of the direction of the “actual” distance between the position of the “follower” magnet N1 at Time t₂ 550′ and the position of the “lead” magnet S1 at Time t₂ 552′.

As will be understood by someone with ordinary skill in the art, gross magnetism (abbreviated herein as “m0”) between the N1 magnetic pole at Time t₂ (element 550′) and the S1 magnetic pole at Time t₂ will be 1/(r′)² (i.e., m0=1/(r′)²).

As depicted in FIG. 5D, in view of r′ 570, element 586 graphically depicts gross magnetic pull (which is equal to the cosine of the angle theta (θ) multiplied by gross magnetism (m0)).

Element 584 graphically depicts the angle depicted as 180 degrees minus 2 times the angle theta (θ). Element 582 represents the angle depicted as angle theta (θ). Element 574 graphically represents the angle depicted as 90 degrees minus 2 times the angle theta (θ).

Element 580 graphically depicts a tangential correction vector which is equal to the sin of the angle 574 (90 degrees minus 2 times the angle theta (θ) times the sin of the angle theta (θ) times gross magnetism (m0)).

Element 581 graphically depicts a radial correction vector that is equal to the cosine of angle 574 (90 degrees minus 2 times the angle theta (θ)). Element 583 graphically depicts a 90 degree angle formed between the tangential correction vector 580 and the radial correction vector 581.

Element 578 graphically depicts the gross tangential magnetic pull (also sometimes referred to as the gross tangential magnetic acceleration) which is equal to the sin of the angle theta (θ) times gross magnetism (m0).

As will be understood by someone with ordinary skill in the art, the above-described geometric depictions of magnetic forces and magnetic force vectors graphically represent magnetic forces and force vectors that would be created by an exemplary lead magnetic pole, such as exemplary South Magnetic Pole S2 (elements 552 at Time t₁ and 552′ at Time t₂) and exemplary North Magnetic Pole N1 (elements 550 at Time t₁ and 550′ at Time t₂) as those two opposing-magnetic poles mutually orbit around an exemplary central point (549) in the orbital direction graphically depicted as orbit direction P-P′ in an exemplary embodiment that mutually orbits a plurality of alternating opposing magnetic poles.

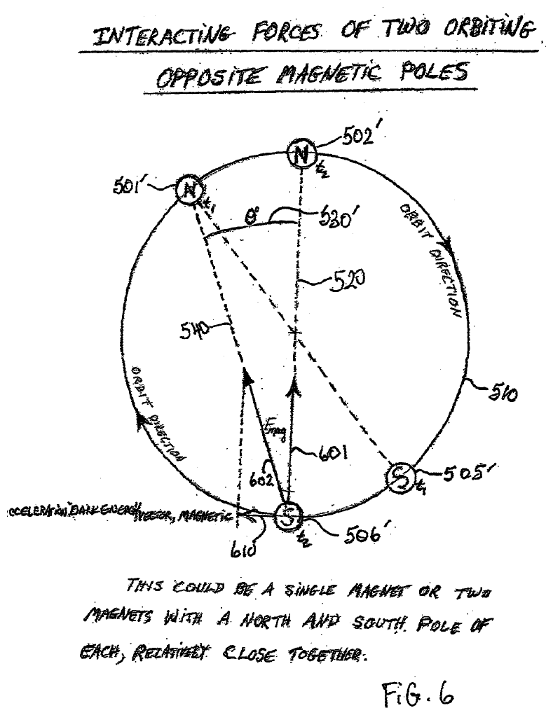

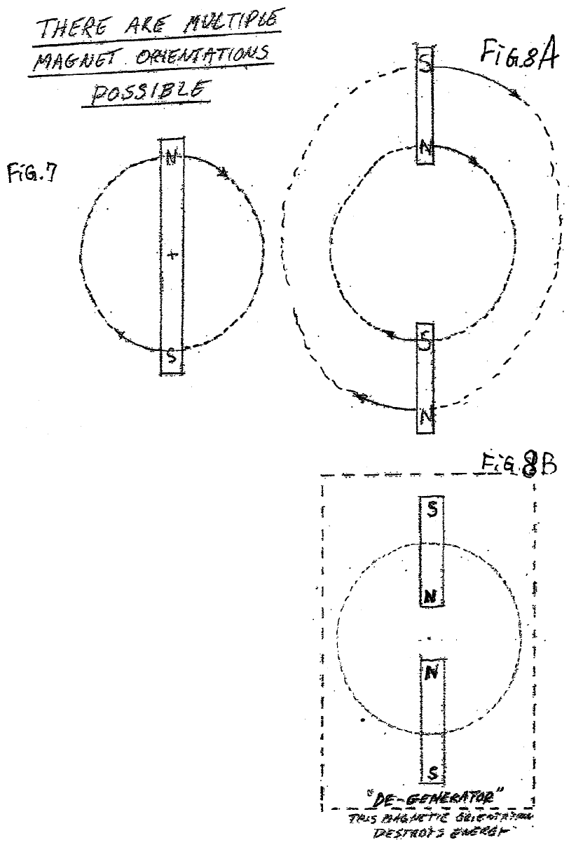

FIG. 6 illustratively depicts exemplary interacting magnetic forces and magnetic force vectors that would be created by mutually orbiting two opposite magnetic poles that are diametrically opposed in position on the mutual orbit. The exemplary interacting forces between the two orbiting opposite magnetic poles could be exhibited by simply “spinning” a single magnet (see, e.g., FIG. 7), or alternatively, could be created by mutually orbiting two magnets, with the North Pole of one magnet relatively close to the opposing South Pole of the second magnet. See, for example, exemplary embodiments depicted in FIGS. 11-13 and 15-17.

Returning with reference to FIG. 6, as illustratively depicted in FIG. 6, for a first magnet and a second magnet mutually orbiting around an exemplary mutual orbit 510, a magnetic force F_{mag} 602 would be exhibited between the South Pole 506′ at time t₂ of one magnet (the exemplary following magnet), and the opposing North Pole 501′ of a second magnet (the exemplary leading magnet) at time t₁. As further illustrated in FIG. 6, as a result of the mutual orbit of the leading North Pole 501′ magnet and the following South Pole 506′ magnet, an exemplary magnetic acceleration force vector 610 (sometimes referred to herein as a magnetic “Dark Energy” (“DE”) Vector) would be generated; the exemplary magnetic acceleration force vector 610 would affect the orbit of the South Pole 506′ of the following magnet at time t₂. Exemplary magnetic acceleration force vector 610 would tend to magnetically attract the South Pole 506′ of the following magnet at time t₂ in the direction of the exemplary magnetic acceleration force vector 610. As will be understood by someone with ordinary skill in the art, the exemplary magnetic attraction of the South Pole 506′ of the following magnet at time t₂ in the direction of the exemplary magnetic acceleration force vector 610 would tend to cause the South Pole 506′ of the following magnet to move in the direction of the exemplary magnetic acceleration force vector 610. As will be further understood by someone with ordinary skill in the art, in exemplary embodiments in which the exemplary magnets are tethered together, such as by being embedded in a rotor, the exemplary generation of the exemplary magnetic acceleration force vector 610 would tend to urge the South Pole 506′ of the following magnet to further orbit around the mutual orbit; in such tethered-together embodiments, the tethering of the relative magnets would help prevent the magnets from flying off of their mutual orbit. Exemplary force line 601 represents a hypothetical force vector that would exist if magnetic force was instantaneous, rather than traveling at [only] the speed of light.

As will be further understood by someone with ordinary skill in the art, at the same time that the exemplary magnetic acceleration force vector 610 (sometimes referred to herein as a magnetic “Dark Energy” (“DE”) Vector) would be generated as described above with respect to the South Pole 506′ of the following magnet at time t₂, a similar exemplary magnetic acceleration force vector (not separately shown) would be simultaneously generated by virtue of the South Pole 506′ magnet being the leading magnet as compared to the North Pole 501′ magnet. As will be yet further understood by someone with ordinary skill in the art, the simultaneous generation of the two parallel exemplary magnetic acceleration force vector would tend to urge both of the North Pole 501′ magnet and the South Pole 506′ magnet to further continue along their mutual orbit 510.

One way to harness the energy of the two exemplary orbiting magnets would simply be to surround the rotor, with the two orbiting magnets in the rotor, with a wire coil. Orbiting magnets in a rotor that is surrounded by a wire coil would generate electricity (such as is done, e.g., with wind or water generators).

The orbiting (spinning) magnets will tend to accelerate to the point of flying apart without a constant withdrawal of energy from the system by coil electrical generation, friction, etc.

On Earth, one could spin/orbit one orbiting magnet inside a coil of wire. However, in outer space, the coil of wire may begin a “sympathetic” orbit. Therefore, in outer space, an exemplary outer-space embodiment would orbit two magnets, and the coil(s) of wire would be fixed relative to each other and relative to the orbiting magnets.

The above-given calculations are provided with respect to “point” magnetic charges which can be reasonably approximated by orienting the magnets properly, or by spinning a single magnet as illustratively depicted in FIG. 7. FIGS. 8A-8B depict alternative magnetic acceleration force vector generating orientations of magnets for alternative exemplary embodiments.

In designing an exemplary motor, the following equations would be used:

$$\frac{The magnetic Dark Energy Force}{The static magnetic attractive force} = \frac{Distance magnets travel ( at small thetas )}{Diameter of orbit}$$

Therefore, the tangential magnetic acceleration force vector (sometimes referred to herein as the magnetic “Dark Energy” Force [vector])=(Static magnetic attractive force between magnets)*(distance magnet travels during the time that it takes for the magnetic force to travel distance “r′”)/distance “r′”.

Therefore, the tangential magnetic acceleration force vector (the magnetic “Dark Energy” Force [vector]) is calculated as follows:

$$The Magnetic Dark Energy force = \frac{{\frac{k ( {q}^{*} 2 )}{r 2} * {( [ {RPM}^{*} {2}^{*} ” pi ”}^{*} {r}^{*} \frac{min}{60 sec} ]}^{*} [ 2 {r}^{*} C ] )}{2 r}$$

Pulling out all the constants, then, magnetic acceleration force vector

$$( the magnetic “ Dark energy ” vector ) = {( constant )}^{*} \frac{( RPM )}{{r}^{⋀} 2}$$

Or rephrased, the tangential magnetic Dark Energy acceleration force vector (the magnetic Dark Energy vector) is directly proportional to the RPM and magnetic attractive force, and is inversely proportional to the square of the radius. This means that the closeness of the magnets is more important than the speed at which they orbit, so in order to achieve the maximum power output, the orbiting speed and magnetic strength (which is constant after the radius has been chosen) should be maximized; the magnet spacing should be minimized, which would also help (after fixing their separation distance) maximize constant magnetic strength. This is convenient since the closer radius would lessen the centrifugal force of the spinning magnets allowing higher RPMs. This will be constrained by the tensile strength of the tethering material holding the magnet(s) together while in orbit.

There are many ways in which two magnets could be “tethered” together and spun so that they were spinning opposite poles around a central axis.

One exemplary way to “tether” two (or more) magnets together and rotate them around a mutual orbit is illustratively depicted in FIG. 9A.

The exemplary embodiment illustratively depicted in FIG. 9A would be housed in an ultra-low-friction environment, illustratively depicted as element 990.

An exemplary number of long magnets, for example, six (6) long magnets, e.g., illustratively depicted as element numbers 940-a through 940-f, would be longitudinally imbedded in an exemplary cylinder 930 (an exemplary rotatable mount 930), for example, an epoxy cylinder, that would be rotated by an exemplary central axle 902 connected through an exemplary center 932 of the exemplary cylinder 930.

As will be understood by someone with ordinary skill in the art, the depiction of six exemplary long magnets is illustrative and non-limiting. Other numbers of magnets, and/or other configurations of magnets, long, short, or otherwise, could be provided that would similarly harness the “magnetic dark energy” vectors generated by the rotation of the exemplary magnets.

In this application and/or in the above-referenced papers, incorporated by reference herein, the term “magnetic dark energy” vector may sometimes be alternatively referred to as “magnetic dark force” vector, and/or as the tangential magnetic dark energy force, the tangential magnetic dark energy force vector, the tangential magnetic acceleration force, and/or the tangential magnetic acceleration force vector.

The exemplary axle 902 would be driven initially by an exemplary initial drive motor 901 that would turn the exemplary cylinder 930 in a direction along illustratively depicted exemplary orbital/rotational directional line T-T′.

An exemplary wire coil cylinder 950 would surround, but would not touch, the external perimeter of the exemplary cylinder 930, so that the exemplary cylinder 930 could rotate freely inside exemplary wire coil cylinder 950. Exemplary wire coil cylinder 950 would be housed in, and stably attached to, or otherwise mounted to, an interior of an exemplary motor casing 920 (also sometimes referred to herein as an exemplary stator (920)) so that exemplary wire coil cylinder 950 would not begin to rotate.

Alternating opposing magnetic poles, e.g., exemplary north magnetic poles 941-a, would alternate with exemplary south magnetic poles 941-b. Exemplary wire coil cylinder 950 would provide positive 970 and negative 960 connections to other power generator components (not shown).

The exemplary initial drive motor 901 in the illustrative exemplary embodiment depicted in FIG. 9A would initially rotate the exemplary axle 902 at an ultra-high speed in the exemplary ultra-low-friction environment 990, which would in turn rotate the exemplary cylinder 930 (the exemplary rotatable mount 930), which would in turn cause rotation of exemplary long magnets 940-a through 940-f around an exemplary orbit, illustratively depicted in the direction of exemplary orbital/rotational directional line T-T′.

At ultra-high-speed rotation in the exemplary ultra-low-friction environment 990, exemplary rotating long magnets 940-a through 940-f would generate “magnetic dark energy” vectors (as illustratively explained elsewhere herein and as illustratively depicted in FIG. 9A as, e.g., 995-d), which would attract the next on-coming magnetic pole.

FIG. 9B is an illustrative front plan view of exemplary rotatable mount 930. Turning for further illustration with reference to FIG. 9B, as exemplary rotatable mount 930 is rotated (as was described with respect to FIG. 9A, using exemplary initial drive motor 901 that initially drives exemplary axle 902 to rotate exemplary rotatable mount 930 in the direction of exemplary orbital/rotational directional line T-T′), the exposed magnetic pole, e.g., 941-b (South) or 941-a (North), of each of the exemplary long magnets 940-a through 940-f would become a “leading” magnetic pole/magnet to the magnetic pole/magnet immediately following it around the mutual orbit (in the direction of exemplary orbital/rotational directional line T-T′), i.e., 940-f through 940-e. That is, each exposed magnetic pole, e.g., 941-a of each magnet, e.g., 940-e, would become a “leading” magnetic pole/magnet to the magnet, i.e., magnet 940-d with magnetic pole 941-b, that immediately follows the “leading” magnetic pole/magnet around the mutual orbit.

At sufficiently high speeds, in a sufficiently low-friction environment, the exemplary rotating long magnets (e.g., 940-a through 940-f) would harness the power generated by tangential magnetic acceleration force (“magnetic dark energy”) vectors, e.g., 995-a through 995-f, resulting in rotating magnets 940-a through 940-f to further rotate without further power from exemplary initial drive motor 901.

As was previously described above, element 578 in FIG. 5D graphically depicts the gross tangential magnetic pull (also sometimes referred to as the gross tangential magnetic acceleration); as will be understood by someone with ordinary skill in the art, the previously-above-described magnetic forces and magnetic force vectors would be created by an exemplary lead magnetic pole, such as exemplary South Magnetic Pole S1 (elements 552 at Time t₁ and 552′ at Time t₂) and exemplary North Magnetic Pole N1 (elements 550 at Time t₁ and 550′ at Time t₂) as those two opposing-magnetic poles mutually orbit around an exemplary central point (549) in the orbital direction graphically depicted in FIG. 5D as orbit direction P-P′ in an exemplary plurality-of-magnets embodiment that mutually orbits a plurality of alternating opposing magnetic poles; those exemplary magnetic forces and magnetic force vectors would tend to urge the magnets in such a plurality-of-magnets embodiment to continue to rotate around their mutual orbit.

Returning with reference to FIGS. 9A and 9B, after the above-described initial rotation of the exemplary axle 902 by exemplary initial drive motor 901, further rotation of the exemplary axle 902 would then be driven by the ongoing rotation of exemplary long magnets 940-a through 940-f, which would be then driven by the power generated by the exemplary tangential magnetic acceleration (“magnetic dark energy”) vectors, e.g., 995-a through 995-f as shown in FIG. 9B.

Rotation of exemplary axle 902 would drive rotation of exemplary cylinder 930, which would in turn rotate alternating opposing magnets 940-a through 940-l inside exemplary wire coil cylinder 950, which would generate power through exemplary positive 970 and negative 960 connections to other power generator components (not shown).

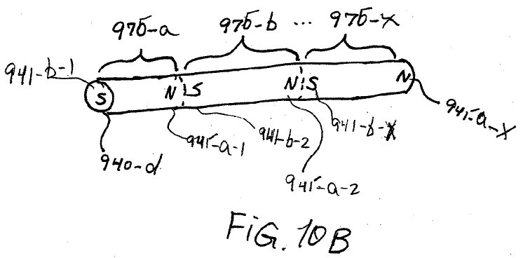

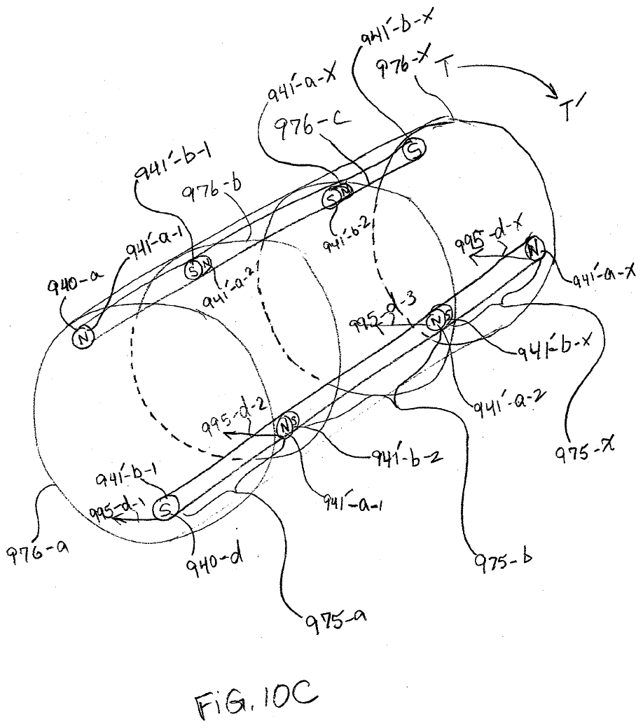

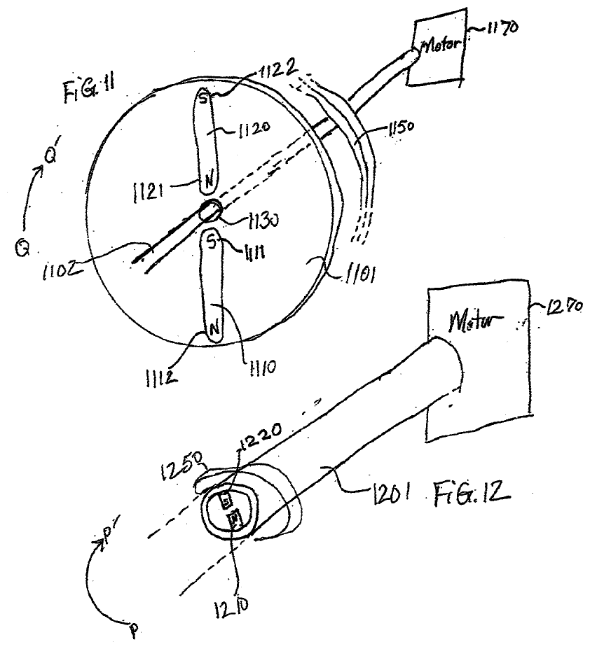

FIG. 10A illustratively depicts an alternative exemplary plurality-of-magnets embodiment of the present invention; FIG. 10B illustratively depicts an exemplary segmented-magnet configuration for providing an exemplary [segmented] “long” magnet” in an alternative exemplary plurality-of-magnets embodiment of the present invention.

As depicted in FIG. 10B, an exemplary “long” magnet 940-d would be comprised of exemplary magnet segments 975-a, 975-b 975-x; each exemplary segment (975-a, 975-b 975-x) would have an exemplary North Magnetic Pole (e.g., 941′-a-1, 941′-a-2 941′-a-x) and an exemplary South Magnetic Pole (e.g., 941′-b-1. 941′-b-2 941′-b-x). The opposing ends of the exemplary magnet segments 975-a, 975-b 975-x will tend to magnetically attract to hold the exemplary magnet segments 975-a, 975-b 975-x together in each corresponding exemplary “long” magnet.

As will be understood by someone with ordinary skill in the art, the alternative exemplary plurality-of-magnets embodiment depicted in FIG. 10A would work similarly to the exemplary embodiment depicted in FIGS. 9A and 9B, except that, as will be understood by someone with ordinary skill in the art, as depicted in FIG. 10C, mutually orbiting exemplary segmented magnets such as 975-a, 975-b 975-x, would tend to embody multiple exemplary mutual orbits 976-a, 976-b, 976-c . . . . 976-x, which would, in turn, generate multiple, orbit-specific occurrences of corresponding exemplary tangential magnetic acceleration (“magnetic dark energy”) vectors (e.g., 995-d-a, 995-d-2, 995-d-3 . . . 995-d-x).

Another exemplary way to “tether” two magnets together and rotate them in a mutual orbit is depicted in FIG. 11. As illustratively depicted in FIG. 11, two exemplary magnets 1110 and 1120 would be imbedded in an exemplary wheel 1101, for example, an epoxy wheel, that would be rotated by an exemplary central axle 1102 connected through an exemplary center 1130 of the exemplary wheel 1101. An exemplary wire coil 1150 would surround, but would not touch, the perimeter of the exemplary wheel 1101, so that the exemplary wheel 1101 could rotate freely. Opposing poles, e.g., exemplary North Pole 1121 of exemplary magnet 1120 would face exemplary South Pole 1111 of exemplary magnet 1110. The exemplary axle 1102 would be driven initially by an exemplary motor 1170 to turn the exemplary wheel 1101 in a direction along directional line Q-Q′. Exemplary wire coil 1150 would be connected (not shown) to other power generator components (not shown) to harness the power generated by rotating magnets 1101 and 1120.

Another exemplary way to “tether” two magnets together and rotate them in a mutual orbit is depicted in FIG. 12. As depicted in FIG. 12, two exemplary opposite pole-facing magnets 1210 and 1220 would be housed inside an “axle” 1201 that would be driven initially by an exemplary motor 1270 to turn the exemplary axle 1201 in a direction along directional line P-P′. In such an exemplary embodiment, the opposite pole-facing magnets 1210 and 1220 would be fastened, such as in slots, inside an interior wall of the exemplary axle 1201. An exemplary wire coil 1250 would surround, but would not touch, the perimeter of the exemplary axle 1201, so that the exemplary axle 1201 could rotate freely. Exemplary wire coil 1250 would be connected (not shown) to other power generator components (not shown) to harness the power generated by rotating magnets 1201 and 1220.

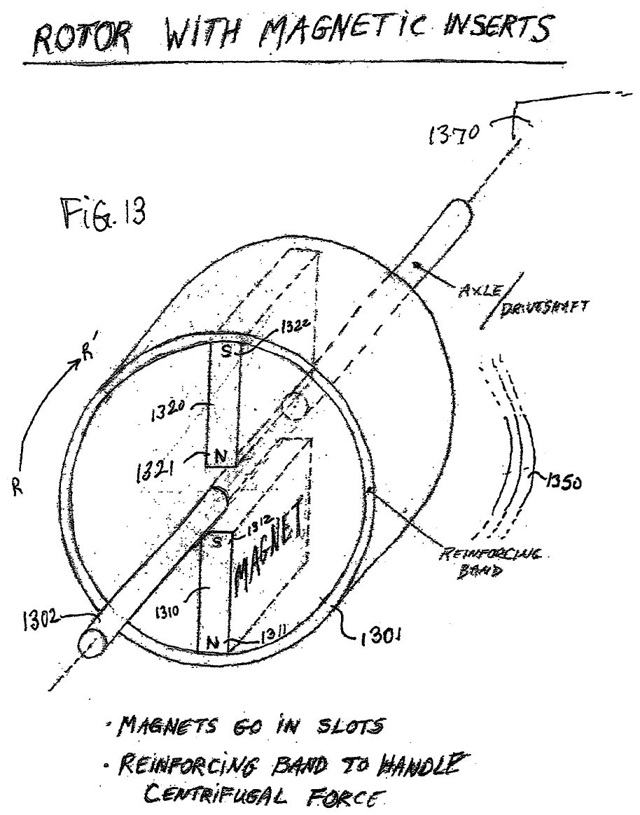

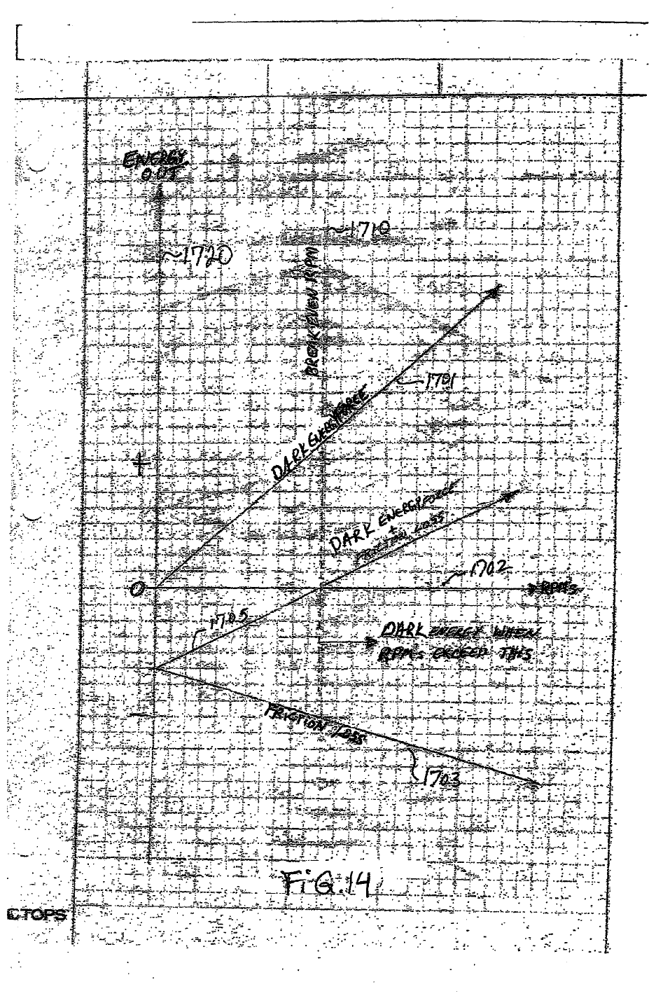

Yet another exemplary way to “tether” two magnets together and rotate them in a mutual orbit is depicted in FIG. 13. FIG. 13 depicts an exemplary cut-away view of an exemplary rotor cylinder 1301. As depicted in FIG. 13, two exemplary opposite pole-facing magnets 1310 and 1320 would be housed inside an exemplary rotor cylinder 1301. The exemplary rotor cylinder 1301 would feature an exemplary reinforcing band to handle centrifugal force by the magnets. The exemplary opposite pole-facing magnets 1310 and 1320 would be imbedded in, or otherwise connected in, such as in slots, exemplary rotor cylinder 1301 so that opposing poles, e.g., exemplary North Pole 1321 of exemplary magnet 1320 faces exemplary South Pole 1312 of exemplary magnet 1310. An exemplary axle 1320 would be connected at one end to an exemplary motor 1370, and would turn the exemplary rotor cylinder 1301 in in a direction along directional line R-R′. Exemplary rotor cylinder 1301 may taper (not shown) to connect at each end to exemplary axle 1302. An exemplary wire coil 1350 would surround, but would not touch, the perimeter of the exemplary rotor cylinder 1301, so that the exemplary rotor cylinder 1301 could rotate freely. Exemplary wire coil 1350 would be connected (not shown) to other power generator components (not shown) to harness the power generated by rotating magnets 1301 and 1320.

The wire coils described above could be relatively standard generator coils, but should be located as close as possible to the orbiting magnets without interfering with their movement. Instead of copper wiring, in some exemplary embodiments, silver wire would be used. In other exemplary embodiments, such as in outer space applications, a superconducting coil would be used.

On earth, a relatively high gravity situation, it would be beneficial to minimize friction of the spinning magnets, including spinning the magnets in a vacuum. Ideally, the magnets on a rotor would touch nothing. These might be magnetically levitated bindings which currently have the capability to hold large rotating masses up to approximately 4.5 million RPM. As described further below, in some exemplary embodiments, the rotor might be placed in a vertical orientation which might allow an additional reduction of friction loss.

In some exemplary embodiments (not shown), as the magnets are rotated in one orbit direction, the surrounding wire coil would be rotated in an opposing orbital direction.

Friction usually rises as the RPM increases. The exemplary magnetic acceleration force vector generator would generate more energy with a higher RPM beginning with zero energy produced at zero RPM going up to a theoretical “maximum” near 64% of the static magnetic attraction (in view of the illustratively “assumed” speed of light for the speed at which magnetism (and gravity) travel).

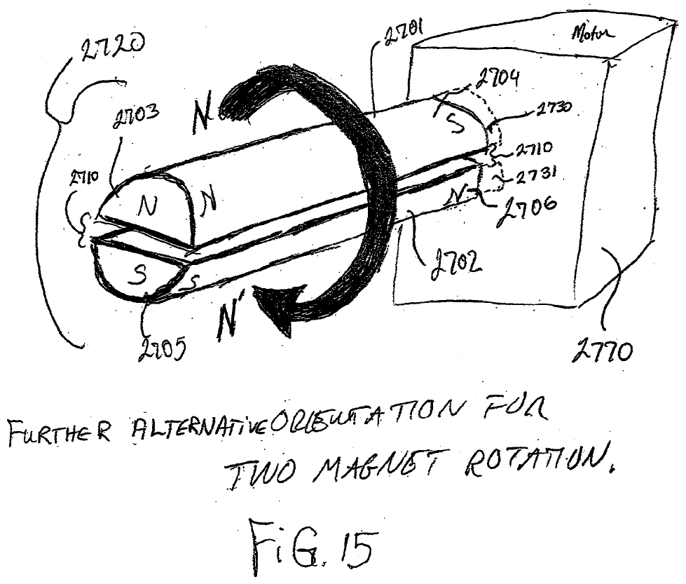

There is a breakeven point where the extra “Dark Energy” accelerating force exceeds the rotating friction allowing clean, limitless energy production. FIG. 14 illustratively depicts the relationships between increases in RPMs, the magnetic acceleration force, and friction loss.

Alternatively, as depicted in FIG. 13, a conventional motor 1370 could be used to drive the Magnetic Dark Energy generator up to a speed sufficient to generate the Magnetic Dark Energy accelerator force. At sufficient RPMs, the exemplary embodiment then, would become a power generator. At such RPMs, the Magnetic Dark Energy generator would generate sufficient force to turn itself and to provide energy output for other uses.

In some exemplary embodiments, instead of using permanent magnets, far more powerful electromagnets would be used in order to increase the static magnetic attractive force.

The key fundamentals that drive power generation in exemplary generator embodiments are high orbiting speeds, small r, and correct magnetic pole orientation. If the two closest poles are north/south, power would be created.

However, if the facing poles are in a north/north or south/south orientation, energy would be “uncreated” or made to vanish without a trace. This effect would act like heatless friction and could be used for cooling. That is, by reversing the poles of the magnets so that same-poles face each other (e.g., having two North Poles orbiting closely about another), a magnetic decelerating force would be created. Such a magnetic decelerating force would tend to slow the orbiting magnets down by an equal and opposite force, as compared to the previously above-described attractive force. A spinning disk with two North Poles in close proximity would tend to slow to a stop but without generating a commensurate heat build-up as would occur if the disk had been decelerated by friction. Such a net loss of energy might be used for cooling or any energy dissipation.

A. Laterally-Magnetized Axle Embodiment

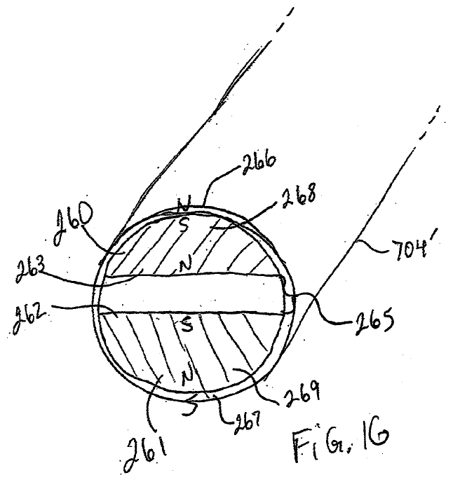

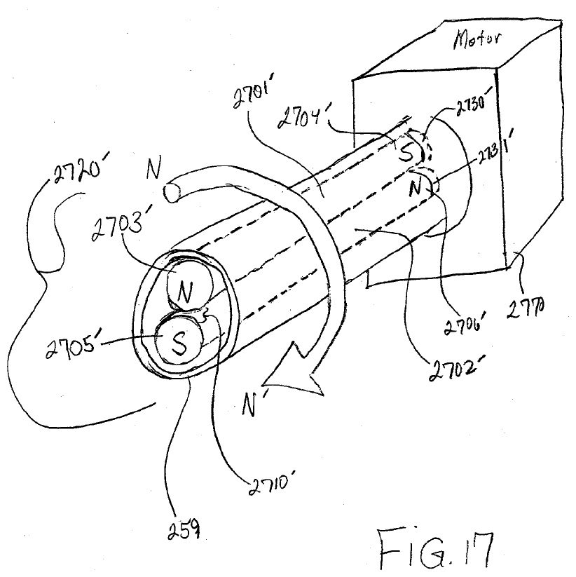

As illustratively depicted in FIG. 16, as an alternative to a single dipole axle 704, two laterally-magnetized rods 260 and 261 could be encased inside an alternative laterally-magnetized axle casing 704′ so that opposing magnetic poles 262 (e.g., S) and 263 (e.g., N) face each other, separated by a small distance 265; a “N” pole 266 of laterally-magnetized axle casing 704′ would contact a “S” pole 268 of laterally-magnetized rod 260; a “S” pole 267 of laterally-magnetized axle casing 704′ would contact a “N” pole 269 of laterally-magnetized rod 261. Other than the difference in the illustrative exemplary construction of the above-described two laterally-magnetized rods 260 and 261 that would be encased inside an alternative laterally-magnetized axle casing 704′, the embodiment would work similarly to the embodiment described further below with respect to FIG. 15.

B. A Further Alternative Rotatable Axle Embodiment

FIG. 15 illustratively depicts an axle feature of a yet further alternative exemplary embodiment of the present invention in which opposing magnetic poles (2703 and 2705, and 2704 and 2706) of two, flat-sided, rod magnets 2701 and 2702, would be counter-posed to form an exemplary two-piece rotatable axle 2720. In one further alternative exemplary rotatable axle embodiment, the two, flat-sided, magnetic rods comprising an exemplary two-piece rotatable axle 2720 would be fastened into an exemplary motor 2770 that would initially drive the exemplary two-piece rotatable axle 2720 to rotate, e.g., in rotational directional line N-N′. In one such further alternative exemplary rotatable axle embodiment, exemplary North-magnet pole 2703 of a first flat-sided, magnetized rod 2701 would be counter-posed to, and separated by an exemplary gap 2710 from, an exemplary South-Magnetic Pole 2705 of a second flat-sided, magnetized rod 2705; exemplary South-Magnet Pole 2704 of the first flat-sided, magnetized rod 2701 would be counter-posed to, and separated by the exemplary gap 2710 from, an exemplary North-Magnetic Pole 2706 of the second flat-sided, magnetized rod 2705.

Exemplary distal end 2730 of the first flat-sided, magnetized rod 2701 and exemplary distal end 2731 of the second flat-sided, magnetized rod 2705 would be set in, or otherwise fastened into, respective exemplary slots (not shown) in exemplary motor 2770, which would operate to initially drive the exemplary two-piece rotatable axle 2720 to rotate, e.g., in rotational directional line N-N′.

FIG. 17 illustratively depicts an axle feature of a still further alternative exemplary embodiment of the present invention in which opposing magnetic poles (2703′ and 2705′, and 2704′ and 2706′) of two round-rod (cylindrical) magnets 2701′ and 2702′, would be counter-posed inside an exemplary cylindrical casing 259 to form an exemplary rotatable axle 2720′. In one such further alternative exemplary rotatable axle embodiment, the two round rod magnets 2701′ and 2702′ counter-posed inside exemplary casing 259 and comprising exemplary rotatable axle 2720′ would be fastened into an exemplary motor 2770 that would initially drive the exemplary rotatable axle 2720′ to rotate, e.g., in rotational directional line N-N′. In one such further alternative exemplary rotatable axle embodiment, exemplary North-Magnet Pole 2703′ of a first round magnetized rod 2701′ would be counter-posed to, and separated by an exemplary gap 2710′ from, an exemplary South-Magnetic Pole 2705′ of a second round magnetized rod 2702′; exemplary South-Magnet Pole 2704′ of the first round magnetized rod 2701′ would be counter-posed to, and separated by the exemplary gap 2710′ from, an exemplary North-Magnetic Pole 2706′ of the second round magnetized rod 2705′.

In another such further alternative exemplary rotatable axle embodiments, the exemplary first round magnetized rod 2701′ would not be separated from the second round magnetized rod 2705′; rather, they would touch along a lateral portion; exemplary “gap” 2710′ would be zero.

In one such further alternative exemplary rotatable axle embodiment, exemplary distal end 2730′ of the first round magnetized rod 2701′ and exemplary distal end 2731′ of the second round magnetized rod 2705′ would be set in, or otherwise fastened into, respective exemplary slots (not shown) in exemplary motor 2770, which would operate to initially drive the exemplary rotatable axle 2720′ to rotate, e.g., in rotational directional line N-N′.

### Facsimile Reproduction of Copyright Material

A portion of the disclosure of this patent document contains material which is subject to copyright protection by the copyright owner, Charles D. Cole, III, and/or his successors and/or his assigns. The copyright owner has no objection to the facsimile reproduction by anyone of the patent document or the patent disclosure, as it appears in the U.S. Patent and Trademark Office patent file or records, but otherwise reserves all copyright rights whatsoever.

### Illustrative Embodiments

Although this invention has been described in certain specific embodiments, many additional modifications and variations would be apparent to those skilled in the art. It is, therefore, to be understood that this invention may be practiced otherwise than as specifically described. Moreover, to those skilled in the various arts, the invention itself herein will suggest solutions to other tasks and adaptations for other applications. Thus, the embodiments of the invention described herein should be considered in all respects as illustrative and not restrictive, the scope of the invention to be determined by the appended claims and their equivalents rather than the foregoing description.

1. An apparatus that produces a dark energy magnetic acceleration force, said apparatus comprising:
a high-speed rotor that orbits two opposing-magnetic poles from one or more magnets around a mutual orbit, generating a dark energy magnetic acceleration force that magnetically attracts a first magnetic pole of said two opposing-magnetic poles at a particular time to a magnetic force emitted by a second magnetic pole of said two opposing-magnetic poles at an earlier time; and
a wire coil that receives as electrical energy a rotation of said two opposing-magnetic poles around said mutual orbit, said rotation caused, at least in part, due to said dark energy magnetic acceleration force magnetically attracting said first magnetic pole of said two opposing-magnetic poles at a particular time to said magnetic force emitted by said second magnetic pole of said two opposing-magnetic poles at said earlier time, said wire coil transferring said electrical energy for power generation.

2. The apparatus of claim 1, said orbiting two opposing-magnetic poles of one or more magnets orbiting within a vacuum.

3. The apparatus of claim 1, said orbiting two opposing-magnetic poles of one or more magnets orbiting within a low-friction environment.

4. An apparatus that produces clean energy from a dark energy magnetic acceleration force, said apparatus comprising:
at least one ultra, high-speed spinning magnet spinning in an ultra-low friction environment, said at least one ultra, high-speed spinning magnet generating a dark energy magnetic acceleration force; and
an energy capturing apparatus that captures said dark energy magnetic acceleration force and generates from said dark energy magnetic acceleration force, clean power.

5. The apparatus of claim 4, said apparatus further comprising:
a laterally magnetized magnet spinning around a lateral axis of said magnet.

6. The apparatus of claim 4, said at least one ultra, high-speed spinning magnet spinning in a vacuum.

7. (canceled)

8. An apparatus that produces energy due, at least in part, to an attraction of a first opposing-magnetic-pole of a following magnet that is orbiting around an orbit, to an opposite magnetic force emitted by a second opposing-magnetic-pole of a leading magnet, that is mutually orbiting around said orbit, said first-opposing-magnetic-pole of said following magnet magnetically attracted to said opposite magnetic force emitted by said second opposing-magnetic-pole of said leading magnet according to a tangential magnetic acceleration force generated by said mutual orbiting of said leading magnet and said following magnet around said orbit.

9. The apparatus of claim 8, said apparatus further comprising:
an initial drive motor;
a rotor, said rotor attached at a first portion to said initial drive motor, said rotor attached at a second portion to a rotational mount, said rotational mount presenting a plurality of opposing-magnetic-poles of a plurality of magnets such that each magnetic pole of said plurality of opposing-magnetic-poles alternates in opposing magnetic force as compared to a preceding magnetic force of an opposing-magnetic-pole that precedes said magnetic pole around said orbit and as compared to a following magnetic force of an opposing-magnetic-pole that follows said magnetic pole around said orbit.

10. The apparatus of claim 9, wherein said initial drive motor initially rotates said rotor, and wherein said rotor, in turn, rotates said rotational mount, thereby mutually orbiting said plurality of opposing-magnetic-poles of said plurality of magnets.

11. The apparatus of claim 9, wherein said initial drive motor initially rotates said rotor, and wherein said rotor, in turn, rotates said rotational mount, thereby mutually orbiting said plurality of opposing-magnetic-poles of said plurality of magnets at a high speed in a low-friction environment such that the magnetic force of each preceding magnetic pole emits an opposing magnetic force that attracts an alternate opposing magnetic pole of the magnetic pole according to said tangential magnetic acceleration force vector.

12. The apparatus of claim 11, said apparatus further comprising:
a wire coil that freely surrounds said rotational mount, said wire coil receiving electrical energy created when said opposing magnetic force of each preceding magnetic pole attracts said alternate opposing magnetic pole according to said tangential magnetic acceleration force vector, thereby contributing to a further rotation of said rotational mount, said wire coil transferring said electrical energy to at least one power generator, said power generation generating power.

13. The apparatus of claim 11, said apparatus further comprising:
a stator;
a wire coil mounted to an interior of said stator so that the wire coil freely surrounds said rotational mount, said wire coil receiving electrical energy created by rotation of said rotational mount, such that said opposing magnetic force of each preceding magnetic pole attracting said alternate opposing magnetic pole according to said tangential magnetic acceleration force vector contributes to further rotating said rotational mount.

14.-21. (canceled)
